(19) United States
(12) Patent Application Publication
(10) Pub. No.: US 2026/0138009 A1
(43) Pub. Date: May 21, 2026

(54) METHOD, APPARATUS FOR PROCESSING CLOUD GAME, DEVICE, MEDIUM AND PROGRAM PRODUCT

(71) Applicant: Beijing Zitiao Network Technology Co., Ltd., Beijing (CN)

(72) Inventors: Pude ZHOU, Beijing (CN); Yu Yang, Beijing (CN); Qiang Yu, Beijing (CN); Zhixu Tang, Beijing (CN)

(21) Appl. No.: 19/393,220

(22) Filed: Nov. 18, 2025

(30) Foreign Application Priority Data
Nov. 18, 2024 (CN) 202411654317.7

(51) Int. Cl. A63F 13/35; A63F 13/335; A63F 13/79

(52) U.S. Cl. CPC A63F 13/35; A63F 13/335; A63F 13/79

(57) ABSTRACT

Embodiments of the present disclosure relate to a method and apparatus for processing a cloud game, device, media and program product. The method includes: obtaining a request from a first instance of the cloud game for performing a multiplayer networked operation on the cloud game, the cloud game being a single-player game, and the first instance being operated by a target user; determining, based on the request, a plurality of users for performing the multiplayer networked operation, the plurality of users having been assigned a plurality of instances of the cloud game, the plurality of instances being incapable of performing data interaction therebetween and comprising the first instance; determining a second instance of the cloud game available for the multiplayer networked operation by the plurality of users; and providing the second instance for the plurality of users to perform a multiplayer networked operation in the second instance.

### CROSS-REFERENCE TO RELATED APPLICATION(S)

This application claims priority to Chinese Application No. 202411654317.7 filed Nov. 18, 2024, the disclosure of which is incorporated herein by reference in its entirety.

### FIELD

Embodiments of the present disclosure relate generally to the field of cloud gaming technology, and more particularly to a method, an apparatus for processing a cloud game, a device, a medium and a program product.

### BACKGROUND

With the development of live streaming technology, a new information transmission mode is formed during the live streaming process. For example, the streamer may view a movie with the viewer in a live streaming, may present the viewer with an application that he is using during the live streaming, or may present the viewers with a talent show, etc. Such live video streaming provides users with more and more information.

At present, games occupy an increasing proportion in people's daily life, especially playing an increasing role in people's entertainment and daily activities. With the development of the cloud gaming, it has also become possible to live stream the ongoing cloud game during the live streaming process.

### SUMMARY

Embodiments of the present disclosure provide a method, an apparatus for processing a cloud game, a device, a medium and a program product.

According to a first aspect of the present disclosure, a method for processing a cloud game is provided. The method includes obtaining a request from a first instance of the cloud game for performing a multiplayer networked operation on the cloud game, where the cloud game is a single-player game and the first instance is operated by a target user. The method also includes determining, based on the request, a plurality of users for performing the multiplayer networked operation on the cloud game, the plurality of users having been assigned a plurality of instances of the cloud game, the plurality of instances being incapable of performing data interaction therebetween, and the plurality of instances including the first instance. The method also includes determining a second instance of the cloud game available for the multiplayer networked operation by the plurality of users. The method also includes providing the second instance for the plurality of users to perform the multiplayer networked operation in the second instance.

In a second aspect of the present disclosure, an apparatus for processing a cloud game is provided. The apparatus includes a request obtaining module configured to obtain a request for performing a multiplayer networked operation on the cloud game from a first instance of the cloud game, where the cloud game is a single-player game and the first instance is operated by a target user; a plurality of user determination modules configured to determine, based on the request, a plurality of users for performing the multiplayer networked operation on the cloud game, the plurality of users having been assigned a plurality of instances of the cloud game, the plurality of instances being incapable of performing data interaction therebetween, and the plurality of instances including the first instance; a second instance determination module configured to determine a second instance of the cloud game available for the multiplayer networked operation by the plurality of users; and a second instance provision module configured to provide the second instance for a plurality of users to perform the multiplayer networked operation in the second instance.

In a third aspect of the present disclosure, an electronic device is provided that includes at least one processor; and a storage for storing at least one program which, when executed by at least one processor, causes the at least one processor to perform the method of the first aspect of the present disclosure.

In a fourth aspect of the present disclosure, a computer readable storage medium is provided that have a computer program stored thereon which, when executed by a processor, implements the method of the first aspect of the present disclosure.

In a fifth aspect of the present disclosure, a computer program product is provided. The computer program product includes a computer program which, when executed by a processor, implements the method of the first aspect of the present disclosure.

It should be understood that the description in this section is not intended to define key or critical features of the embodiments of the disclosure, nor is it intended to limit the scope of the disclosure. Other features of the present disclosure will become readily apparent from the following description.

### BRIEF DESCRIPTION OF THE DRAWINGS

The foregoing and other objects, features and advantages of the disclosure will be apparent from the following more particular description of exemplary embodiments of the disclosure, as illustrated in the accompanying drawings in which like reference numerals generally refer to like parts throughout the disclosure.

FIG. 1 illustrates a schematic diagram of an exemplary environment in which devices and/or methods of some embodiments of the present disclosure may be implemented;

FIG. 2 illustrates a schematic diagram of an exemplary method for processing a cloud game according to some embodiments of the present disclosure;

FIG. 3 illustrates a schematic diagram of an example of a system architecture for processing a cloud game according to some embodiments of the present disclosure;

FIG. 4 illustrates a schematic diagram of an example of a multiplayer networked operation according to some embodiments of the present disclosure;

FIG. 5 illustrates a schematic diagram of an example for processing a cloud game according to some embodiments of the present disclosure;

FIG. 6 illustrates a schematic diagram of an example for transitioning from single-player operation to networked operation according to some embodiments of the present disclosure;

FIG. 7 illustrates a schematic diagram of an example of an interactive process for transitioning from single-player operation to networked operation according to some embodiments of the present disclosure;

FIG. 8 illustrates a schematic diagram of an example for transitioning from networked operation to single-player operation according to some embodiments of the present disclosure;

FIG. 9 illustrates a schematic diagram of an example of an interactive process for transitioning from networked operation to single-player operation according to some embodiments of the present disclosure;

FIG. 10 illustrates a schematic diagram of an example of another interactive process for transitioning from networked operation to single-player operation according to some embodiments of the present disclosure;

FIG. 11 illustrates a schematic diagram of another example for transitioning from networked operation to single-player operation according to some embodiments of the present disclosure;

FIG. 12 illustrates a schematic diagram of an example of an interactive process for transitioning from networked operation to single-player operation according to some embodiments of the present disclosure;

FIG. 13 illustrates a schematic diagram of another example for transitioning from single-player operation to networked operation according to some embodiments of the present disclosure;

FIG. 14 illustrates a schematic diagram of one example of an interactive process for transitioning from single-player operation to networked operation according to some embodiments of the present disclosure;

FIG. 15 illustrates a schematic diagram of another example of an interactive process for transitioning from single-player operation to networked operation according to some embodiments of the present disclosure;

FIG. 16 illustrates a schematic diagram of another example for transitioning from networked operation to single-player operation according to some embodiments of the present disclosure;

FIG. 17 illustrates a schematic diagram of an example of an interactive process for transitioning from networked operation to single-player operation according to some embodiments of the present disclosure;

FIG. 18 illustrates a schematic diagram of an example of another interactive process for transitioning from networked operation to single-player operation according to some embodiments of the present disclosure;

FIG. 19 illustrates a schematic diagram of a further example for transitioning from single-player operation to networked operation according to some embodiments of the present disclosure;

FIG. 20 illustrates a schematic diagram of an example of an interactive process for transitioning from single-player operation to networked operation according to some embodiments of the present disclosure;

FIG. 21 illustrates a schematic diagram of a further example for transitioning from networked operation to single-player operation according to some embodiments of the present disclosure;

FIG. 22 illustrates a schematic diagram of an example of an interactive process for transitioning from networked operation to single-player operation according to some embodiments of the present disclosure;

FIG. 23 illustrates a schematic diagram of an example of another interactive process for transitioning from networked operation to single-player operation according to some embodiments of the present disclosure;

FIG. 24 illustrates a schematic block diagram of an apparatus for processing a cloud game according to some embodiments of the present disclosure;

FIG. 25 illustrates a schematic block diagram of an example device suitable for use to implement various embodiments of the present disclosure.

Like or corresponding reference numerals refer to like or corresponding parts throughout the several views of the drawings.

### DETAILED DESCRIPTION OF EMBODIMENTS

It is understood that the data involved in this technical solution (including but not limited to the data itself, the obtaining or use of data) shall comply with the requirements of relevant laws and regulations and relevant provisions.

It should be understood that, before the technical solutions disclosed in the embodiments of the present disclosure are used, a user should be informed of the type, usage range, usage scenario, etc. Of personal information involved in the present disclosure and be authorized by the user in an appropriate manner according to relevant laws and regulations.

For example, upon receiving a user's active request, prompt information is sent to the user to explicitly prompt the user that the operation requested to be performed will require obtaining and using personal information to the user. Accordingly, a user can autonomously select whether to provide personal information to software or hardware, such as an electronic device, an application program, a server or a storage medium, which performs the operation of the technical solution of the present disclosure, based on prompt information.

As an alternative but non-limiting implementation, in response to receiving the user's active request, the prompt message may be sent to the user, for example, in the form of a pop-up window in which the prompt message may be presented in text. In addition, the pop-up window may also carry a selection control for the user to select “agree” or “disagree” to provide personal information to the electronic device.

It will be appreciated that the above-described notification and obtaining user authorization processes are merely illustrative and not limiting of implementations of the present disclosure, as other means of satisfying relevant laws and regulations may also be applied to implementations of the present disclosure.

Hereinafter, embodiments of the present disclosure will be described in more detail with reference to the accompanying drawings. While certain embodiments of the disclosure have been illustrated in the accompanying drawings, it should be understood that the disclosure may be embodied in various forms and should not be construed as limited to the embodiments set forth herein. Instead, these embodiments are provided to provide a more thorough and complete understanding of the present disclosure. It should be understood that the drawings and examples of the present disclosure are for illustrative purposes only and are not intended to limit the scope of the present disclosure.

Throughout the description of the embodiments of the present disclosure, the terms “comprise” and “include” and variations of the terms, such as “includes”, “including”, “comprises” and “comprising”, will be understood as open inclusion, which means “including but not limited to”. The term “based on” should be understood as “based at least in part on”. The terms “an embodiment” or “the embodiment” should be understood as “at least one embodiment”. The terms “first”, “second”, and the like may refer to different or identical objects. Other explicit and implicit definitions may also be included below.

In the process of dealing with cloud gaming, there are many problems to be solved. For example, in the process of living streaming a cloud game, the requirements for servers, hardware devices, and live streaming protocols, etc. for live streaming is also increasing. Particularly when the streamer and viewer need to interact, the requirements for hardware device performance and network requirements are high. For example, in a live streaming process, it is currently desirable to perform interactive operations between a streamer and a guest (or viewer) in a game, i.e., to allow both the streamer and guest to operate the game in real-time, and it is generally conceivable to perform the operations in a networked manner. In this case, the game application should also be networked and capable of supporting simultaneous operation by multiple persons.

In a conventional scenario, a central server would typically be established first, or the streamer's device acts as the host device, after which the guest would be invited into the streamer's host device to network operate the game together. However, when the game is originally a single-player cloud game, if the above-mentioned functions are to be realized, the originally single-player game is usually modified into a networked game which supports networked multiplayer operation. However, this modification process is costly, time consuming and labor intensive.

For example, if a single-player cloud game needs to be transformed into a networked game, more technologies are involved, the development content of the server side is increased, and knowledge of Socket programming, message serialization, server deployment and so on is also needed. In addition, in the process of reconstruction, there are some problems, such as complex synchronization scheme, difficult synchronization of physical simulation, extra processing of performance, limited number of synchronization and high cost of debugging and iteration, which greatly increase the cost and difficulty of reconstruction. Therefore, there are still many aspects to be improved in the running and live streaming process for cloud games.

To address at least the above and other potential problems, embodiments of the present disclosure provide a method for processing a cloud game. In this method, a request for performing a multiplayer networked operation on a cloud game may first be obtained at a server from a first instance of the cloud game, where the cloud game is a single-player game and the first instance is single-player operated by a target user. After obtaining a request for performing the multiplayer networked operation on the cloud game, the server further determines a plurality of users for performing the multiplayer networked operation on the cloud game according to the request. A plurality of users have been assigned a plurality of instances of the cloud game and data interaction between the plurality of instances is not possible, and the plurality of instances comprises a first instance. The server would then determine a second instance of the cloud game available for multiplayer networked operation by multiple users. Finally, after determining the second instance of the cloud game, the server provides the second instance for a plurality of users to perform a multiplayer networked operation in the second instance. Through this method, when a user performs a single-player operation in an instance of a cloud game, other users can be matched, and after the matching is successful, the user joins an instance which can perform a multiplayer networked operation together with other users to achieve a multi-user networked operation, reducing the resources consumed by changing a single-player game to a multiplayer game, and improving the user experience.

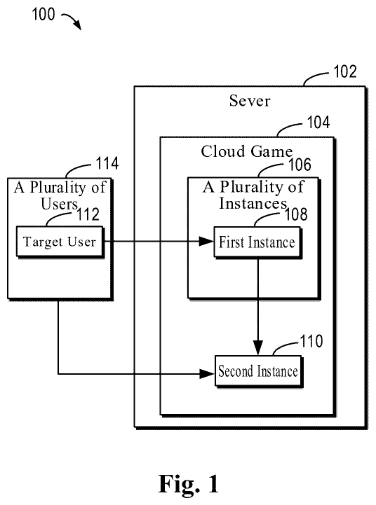

Embodiments of the present disclosure will be described in further detail below with reference to the accompanying drawings. FIG. 1 illustrates an exemplary environment in which devices and/or methods of embodiments of the present disclosure may be implemented. In the environment 100, a target user 112 is operating a first instance 108 of the cloud game 104. The server 102 first obtains a request for performing a multiplayer networked operation on the cloud game 104 through a first instance 108 of the cloud game 104, where the first instance 108 is operated by a single player by the target user 112. After obtaining the request for performing the multiplayer networked operation on the cloud game 104, the server 102 further determines a plurality of users 114 for the multiplayer networked operation according to the request. The target user 112 is one of the plurality of users 114. The plurality of users 114 have been assigned a plurality of instances 106 of the cloud game 104 and no data interaction is possible between the instances of the plurality of instances 106. Next, the server 102 determines a second instance 110 of the cloud game 104 available for multiplayer networked operation by multiple users 114, which may have multiple inputs. Finally, after determining the second instance 110 of the cloud game 104, the server 102 provides the second instance 110 for the plurality of users 114 to perform a multiplayer networked operation in the second instance 110.

Examples of server 102 include, but are not limited to, a server computer, a multiprocessor system, a minicomputer, a mainframe computer, a distributed computing environment that include any of the above systems or devices, and the like.

As shown in FIG. 1, the first instance 108 is an instance of the cloud game 104 created by the server 102 for a target user, and the target user 112 accesses the first instance and performs corresponding operations therein. The target user 112 may perform operations in one of the at least one playback space created by the first instance 108.

The cloud game 104 is a single-player game implemented on a server 104, which may be a cloud server, for example. The server 104 is used to provide game instances. A user can obtain an operation of the user through a cloud game client running locally or a cloud game client running on a host application, and then provides same to a cloud game instance. In addition, the content of the cloud game instance is provided over the network from the server 104 to the target user 112.

The first instance 108 of a cloud game 104 running in the server 102 first receives a request from a cloud game client of the target user 112 for performing a multiplayer networked operation. In some embodiments, the request to perform a multiplayer networked operation for the cloud game is sent by the first instance to a matching service in the server 102, and the sent request contains corresponding identification information. For example, the request contains identification information for the playback space of the first instance, such as the identification of the game room in the game instance, and the user identification of the target user operating the first instance.

In some embodiments, the request may include other information in addition to the identification information of the first instance and the identification information of the target user.

After obtaining the request for performing the multiplayer networked operation on the cloud game 104, the server 102 further determines the plurality of users 114 for performing the multiplayer networked operation according to the request. The plurality of users 114 have been assigned the plurality of instances 106 for the cloud game 104, where each user has a corresponding instance, and data interaction between the plurality of instances 106 is not possible. Additionally, the plurality of instances 106 include the first instance 108.

In addition, the server 102 receives other user identifications that make requests for multiplayer networked operations. The server 102 then determines from the received user identifications a plurality of users that may join the multiplayer networked game initiated by the target user. The server 102 may then also determine a second instance 110 of the cloud game 104 available for multiplayer networked operation by the plurality of users 114.

In some embodiments, the second instance 110 is an instance of a new cloud game. In some embodiments, the second instance 110 is a cloud game instance of the plurality of instances. In some embodiments, the number of the plurality users of an instance of the cloud game cannot exceed the threshold number. In one example, the threshold number of users for an instance of a cloud game is six.

Finally, after determining the second instance 110 of the cloud game 104, the server 102 provides the second instance 110 for a plurality of users 116 to perform a multiplayer networked operation in the second instance 110. For example, the cloud game service in the server 102 provides the identification of the second instance available for multiplayer networked operations to the cloud game client of each of the plurality of users. Thus, each user's cloud game client may determine which instance of the cloud game to join. Each respective cloud game client may then send a request to the second instance 110 to join the second instance so that a multiplayer networked operation may be performed. After the multiplayer networked operation has been performed, multiple users may exit the second instance. In some embodiments, after exiting the second instance, the plurality of users may return back to the previous instance to continue the gaming operation. In some embodiments, after exiting the second instance, the game service generates a new game instance for each of the plurality of users for use by each user.

In some embodiments, the second instance includes a plurality of playback spaces, where each playback space is available to one of the plurality of users for operation of the cloud game, and the number of playback spaces in the second instance is greater than or equal to the number of the plurality of users joining the multiplayer networked operation. The multiple playback spaces provide information for different views or different presentations of the same game instance.

Through this method, when the user operates in the instance of the single-player cloud game, the game instance can be matched to other users to achieve multi-user networked operation, which reduces the resources consumed by changing the single-player game to the conventional multiplayer networked game and improves the user experience.

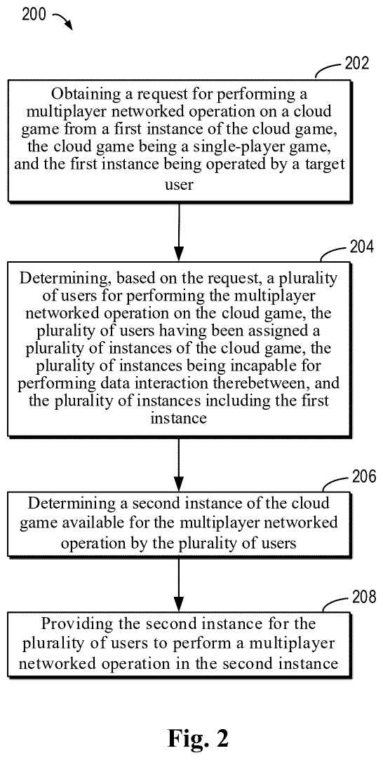

The schematic diagram of an exemplary environment in which devices and/or methods of some embodiments of the present disclosure may be implemented is described above in connection with FIG. 1, and a schematic diagram of an exemplary method for processing a cloud game according to some embodiments of the present disclosure is described below in connection with FIG. 2. The method of FIG. 2 may be performed by server 102 of FIG. 1 or any suitable computing device.

As shown in FIG. 2, in the exemplary method 200, at block 202, the server 102 obtains a request for performing a multiplayer networked operation on a cloud game from a first instance of the cloud game. The cloud game is a single-player game and the first instance is operated by a target user in a single-player manner. The cloud game is to place information about a locally placed game instance in a conventional single-player game on a cloud server, and provide a user operation to the game instance run by the cloud game client, and pull a game audio and video stream from the game instance. Additionally, the cloud game client may be integrated into an application, which may be referred to as a host application for the cloud game client. Additionally, the host application may live the scene of the game instance presented in the cloud game client.

Although the cloud game is a single-player cloud game, an instance of the cloud game may receive multiple inputs so that the single-player cloud game may be operated by multiple users simultaneously. For example, the single-player cloud game may be operated simultaneously by six users.

Generally, when a target user wants to perform a multiplayer networked operation, a matching request for performing the multiplayer networked operation can be issued to a corresponding instance through a cloud game client. After receiving the matching request, the instance generates a request for performing a multiplayer networked operation on the cloud game and sends the request to the matching service, and the sent request contains corresponding identification information. For example, the request contains identification information of the playback space of the first instance and the user identification of the target user operating the first instance.

Then, at block 204, the server 102 determines, based on the request, a plurality of users for multiplayer networked operation of the cloud game, where the plurality of users have been assigned a plurality of instances of the cloud game, the plurality of instances are incapable of performing data interactions therebetween, and the plurality of instances comprising a first instance. In order to implement a multiplayer networked operation for a cloud game, it is necessary to first determine which users may join the multiplayer networked operation according to the request.

As described above, the request may include the user identification of the target user and the identification of the playback space in the first instance to facilitate the server identifying that the request is from the first instance of the plurality of cloud game instances generated by the cloud game.

In addition, since the users who need to join the multiplayer networked operation all need to transmit requests to the matching service in the server, the matching service can obtain a user cluster who wants to join the multiplayer networked operation of the cloud game. The user cluster includes the target user and all other users who want to join the multiplayer networked operation. Then, the server performs a matching operation in the user cluster, so that it can be determined that a plurality of users including a target user perform a multiplayer networked operation together. In an example, the server randomly selects a plurality of users including the target user for a multiplayer networked operation. In another example, the server may group users into different groups based on user identification and related information. The users are divided into different groups, e.g., according to game information. The plurality of users are selected only among users in the same group as the target user. The foregoing examples are merely illustrative of the present disclosure and are not to be construed as limiting thereof. The plurality of users may be obtained in any suitable manner by those skilled in the art.

In some embodiments, the plurality of users control the cloud game for the cloud game client by operating the cloud game client. Additionally, the cloud game creates a plurality of instances for the plurality of users, where each of the plurality of instances is individually operated by each of the plurality of users.

Additionally, the cloud game client corresponding to each of the plurality of users runs on the user's target application, which may be an application including any suitable functionality, such as an application that may be live.

Next, at block 206, the server 102 determines a second instance of the cloud game available for the multiplayer networked operation by multiple users. In order to implement the multiplayer networked operation, the server needs to determine an instance of the cloud game that may perform the multiplayer networked operation, so that multiple users may enter the instance to perform the multiplayer networked operation.

After the matching service determines a plurality of users, identification information about the matched users may be sent to a plurality of cloud game instances corresponding to the plurality of users. The plurality of cloud game instances further send the matching result to the game service to determine from the game service a second instance in which the multiplayer networked operation is possible.

In some embodiments, after determining the plurality of users joining the multiplayer networked operation and determining the number of the plurality of users, the cloud game further creates a second instance, the created second instance having at least the number of playback spaces. Thus, each user may have one playback space and the second instance may provide one data stream for each playback space, e.g., audio and video streams. Further, the data streams presented in each playback space may be different.

For example, the playback space in the second instance is used to be provided to a plurality of users to operate a cloud game. For example, when the plurality of users are five users (including the target user), when the cloud game creates the second instance, five playback spaces are created in the second instance to be provided to the five users respectively to operate in a networked manner in the second instance.

In some embodiments, the predetermined number of playback spaces in the second instance is greater than the number of the plurality of users joining the networked operation. The number of the plurality of users joining the networked operation is five, and the preset number of playback spaces in the second example is six. Additionally, when the preset number of playback spaces in the second instance is greater than the number of the plurality of users joining the networked operation, communication of the remaining playback spaces not joining the networked operation with the users is turned off to save computational resources. In some embodiments, a plurality of instances of the cloud game have been created for the plurality of users prior to the multiplayer networked operation, and the first instance and the second instance are each one of the plurality of instances. Each instance or partial instance of the plurality of instances may contain a preset number of playback spaces, and when the preset number of playback spaces in the plurality of instances or partial instances is greater than or equal to the number of the plurality of users after determining the number of the plurality of users joining the networked operation, one instance may be selected from the plurality of instances as the second instance.

Finally, at block 208, the server 102 provides a second instance for a plurality of users to perform a multiplayer networked operation in the second instance. After the server 102 determines a second instance that the plurality of users may join, the second instance may be provided for the plurality of users to join.

The cloud game client of each of the plurality of users will be able to establish communication with the corresponding playback space in the second instance through the cloud game service. Additionally, the second instance also receives joining requests from a plurality of cloud game clients of the plurality of users, and then establishes communication between the plurality of cloud game clients and corresponding playback spaces in the second instance according to the joining requests.

In some embodiments, after communication is established between the target cloud game client and the corresponding playback space in the second instance, content within the corresponding playback space is provided to the target cloud game client. The contents in the corresponding playback space are game contents of the cloud game.

In some embodiments, where the second instance is selected from the plurality of instances corresponding to the plurality of users, when communication is established between the target cloud game client and the corresponding playback space in the second instance, a request for subscribing to a data stream may be sent to the playback space corresponding to the target user in the second instance via the first instance corresponding to the target user. After receiving a subscription request for subscribing to the corresponding playback space of the second instance, the server pushes the content of the corresponding playback space to the first instance, and then provides the content of the corresponding playback space to the target cloud game client via the first instance. When the networked operation is finished, the subscription of the first instance to the corresponding playback space in the second instance can be cancelled, and the data stream of the corresponding playback space in the first instance can be provided to the target cloud game client again.

In some embodiments, the networked operation actively ends after the target user actively closes the networked operation request. Additionally, after the plurality of users have voted, and a number of users greater than or equal to a threshold number of users agree to close the networked operation, the networked operation ends, e.g., the threshold number of users is 50% of the number of users.

In some embodiments, the first instance is maintained while the second instance is provided for networked operation by the target user in the second instance. For example, after the target user starts a networked operation, association information between the first instance and the target user is retained, for example, state information about a game played by the target user, such as a game progress of a cloud game in a playback space in the first instance, and the association information is stored in association in a cloud game server or a cloud game client for the cloud game. Thus, when the networked operation is completed, the target user returns to the playback space of the first instance to continue using the previous game progress for operation. In addition, game instances for other users of the plurality of users may also be maintained. Thus, other users may also return to the corresponding playback space of the game instance prior to joining the second instance to continue operation. Additionally, respective cloud game related information, such as game progress, is stored in association in the cloud game server for the cloud game, respectively, and may also be stored in the cloud game client. Additionally, at the beginning of the networked operation, progress of the cloud game operated before each of a plurality of users is networked is cleared to save storage space.

In some embodiments, when a networked operation begins, the original plurality of instances are deleted to save occupied storage space. When the networked operation ends, a plurality of users do not enter the previous instance for operation. Instead, operations are performed in the corresponding playback space in the recreated multiple instances. Thus, the target user also does not enter the original first instance to operate in, but instead operates in the playback space in one of the recreated multiple instances.

It should be understood that the foregoing is only illustrative of the present disclosure and is not intended to be a specific limitation thereof. By this method, when a user performs a single-player operation in an instance of a cloud game, the user can join an instance which can be used for multiplayer networked operation with other users to realize multi-user networked operation, so that the single-player cloud game which cannot achieve networked operation via a network can be transformed into a networked cloud game for multiplayer operation, and the user experience is improved.

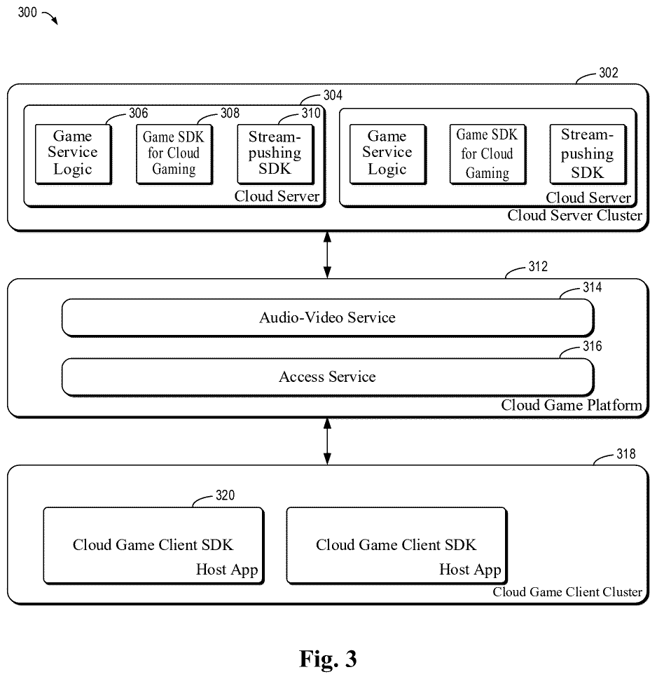

The schematic diagram of an exemplary method for processing a cloud game according to some disclosed embodiments is described above in connection with FIG. 2. A schematic diagram of an example of a system architecture for processing a cloud game according to some embodiments of the present disclosure is described below in conjunction with FIG. 3.

In the example 300 shown in FIG. 3, a cloud server cluster 302 includes a plurality of cloud servers 304 for cloud games. Each of the cloud servers 304 includes a game service logic 306 for cloud games, a game Software Development Kit (SDK) for cloud gaming 308 and a stream-pushing SDK 310. SDK is a third-party toolkit integrated in Application (APP), which may integrate single-player cloud game client into target APP.

The cloud server is a machine for actually running the cloud game, and at the same time, the cloud server also establishes a link with the cloud game platform, and also sends the cloud game data to the cloud game platform. For example, the audio and video data of the cloud game is transmitted to the cloud game platform.

The stream-pushing SDK 310 in the cloud game server is mainly used for transmitting the audio and video of the cloud game, i.e., pushing the audio and video of the cloud game to the cloud game platform. The stream-pushing SDK also interacts with the game SDK for cloud gaming 308 so as to obtain audio and video data of the cloud game for subsequently pushing the audio and video data.

The game SDK for cloud gaming 308 in the cloud game server is integrated within the cloud game and may interact with the cloud game. At the same time, the cloud game SDK is also used to interact with the cloud game platform so as to receive an execution strategy issued by the cloud game platform for the cloud game, for example, an operation instruction for the cloud game, etc.

The cloud game platform 312 is used for receiving audio and video data for a cloud game from a cloud game server. It mainly has an access service 316 and an audio-video service 314. The access service is primarily responsible for distributing machines and initiating games, and the audio-video service 314 is primarily responsible for audio-video related business logic.

The cloud game client cluster 318 includes a plurality of cloud game client SDKs 320 for cloud gaming, which are integrated within and interact with the host APP.

The cloud game client SDK 320 also provides a visual interface to the player, i.e., audio and video received from the cloud game platform is passed to the player so that the player may perform operation by operating the interface of the cloud game client.

After the cloud game client SDK establishes a connection with the cloud game platform, it is also possible to transmit an operation instruction of a player to the cloud game platform, receive data displayed to the player by the cloud game from the cloud game platform and execute a policy issued by the cloud game platform.

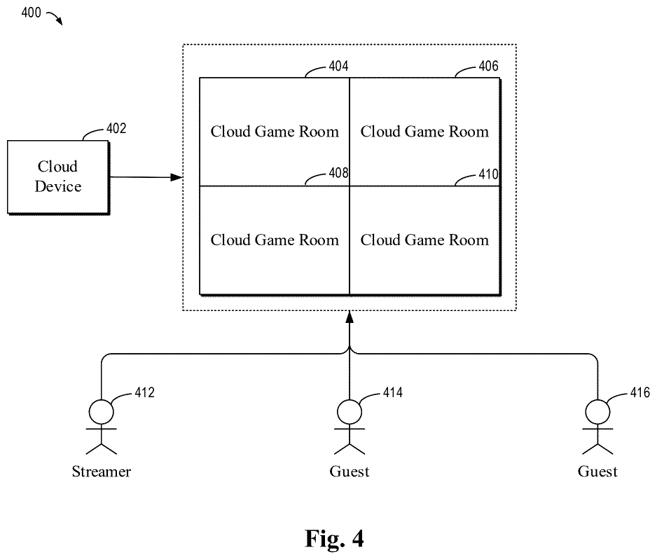

The schematic diagram of an example of a system architecture for processing cloud gaming according to some embodiments of the present disclosure is described above in conjunction with FIG. 3. A schematic diagram of an example of a multiplayer networked operation according to some embodiments of the present disclosure is described below in conjunction with FIG. 4.

In example 400, it can be seen that cloud device 402 includes one instance of a cloud game provided to three users, and this instance includes cloud game room 404, cloud game room 406, cloud game room 408, and cloud game room 410. The instance may have a plurality of user inputs, such as the inputs from the streamer 412, guest 414, and guest 416. Each cloud game room corresponds to a user, e.g., cloud game room 404 corresponds to streamer 412, cloud game room 406 corresponds to guest 414, cloud game room 408 and cloud game room 410 correspond to guest 416 and a further guest X (not shown) respectively.

Further, the cloud game client (SDK) would respectively collect input instructions of the streamer 412, the guest 414 and the guest 416, and then respectively transmit the collected input instructions to the cloud server side for the cloud game via the corresponding cloud game platform, and then the cloud server side would classify the received input instructions according to the user identification of each user, and then transmit the input instructions for the specified user identification to the cloud game.

For example, the streamer 412, the guest 414 and the guest 416 each have a corresponding transmission route in the cloud game. For example, after the input instruction of the streamer 412 is transmitted to the cloud game side via the cloud game platform, the cloud game controls the operation for the cloud game instance according to the received input instruction. At this point, other users may also obtain changes to the video pictures caused by input instruction from the streamer 412.

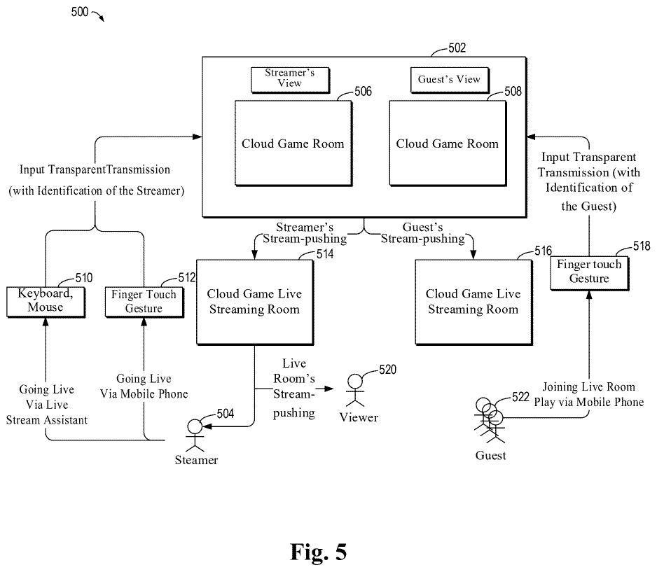

The schematic diagram of an example of networked operation according to some embodiments of the present disclosure is described above in connection with FIG. 4. A schematic diagram of one example for processing a cloud game according to some embodiments of the present disclosure is described below in conjunction with FIG. 5.

In example 500, a streamer 504 may initiate a cloud game at a cloud game client within a host APP. The streamer 504 may choose to use an intelligent device to go live or start a live streaming, for example, using a mobile phone to go live, and at this time the streamer may go live by using a finger touch gesture 512. Alternatively, the streamer may also go live by using a live stream assistant on the computer, in which case a keyboard or mouse 510 may be used for going alive. The cloud game creates a game instance 502 comprising game rooms for different objects. For example, the audio-video stream of the cloud game room 506 is for the streamer 504, which is the audio-video stream viewed from the streamer's view. Additionally, the audio-video stream of the cloud game room 506 may push the cloud game picture to the cloud game live streaming room 514 for the streamer 504 via the streamer's stream-pushing. As such, the cloud game picture may be presented to the streamer 504 and the viewer 520 joining the live streaming room of the streamer via the live streaming room's stream-pushing. The streamer may input relevant operation instructions according to the finger touch gesture 512 or the keyboard or mouse 510, etc. Moreover, identification information of the streamer will be transmitted at the same time as operation instructions are transmitted, so that the game side controls the cloud game instance corresponding to the streamer according to the received identification information.

Further, the guest 522 may also join the game instance 502 by joining live play on an intelligent device such as a mobile phone. After the guest joins a cloud game play method to in the live streaming room of the mobile phone, the cloud game allocates a cloud game room 508 to the guest 522, and therefore the guest's view finally sees an audio-video picture of the cloud game room 508. The guest also inputs a relevant operation instruction according to a finger touch gesture 518, and the identification information of the guest will be transmitted at the same time as transmitting the operation instruction, so that the game side controls a cloud game instance corresponding to the guest according to the received identification information.

After both the streamer and the guest join the cloud game instance and may transmit an operation instruction to the cloud game instance, the cloud game server respectively transmits audio-video information of the cloud game room 506 corresponding to the streamer and of the cloud game room 508 corresponding to the guest to the cloud game platform, and then respectively pushes the audio-video information to the cloud game client via the cloud game platform. On the streamer's stream-pushing side, the cloud game picture is pushed to the streamer's cloud game live streaming room 514 and the live streaming room may push the cloud game picture to the viewer 520 watching the live streaming. In the guest's stream-pushing side, the cloud game picture is pushed to the guest's cloud game live streaming room 516. Additionally, pictures from the guest's live streaming room may also be pushed to viewers joining the live streaming room.

In some embodiments, the number of guests is no more than 6. It should be understood that the above examples are for the purpose of describing the present disclosure only and are not intended as specific limitations thereon.

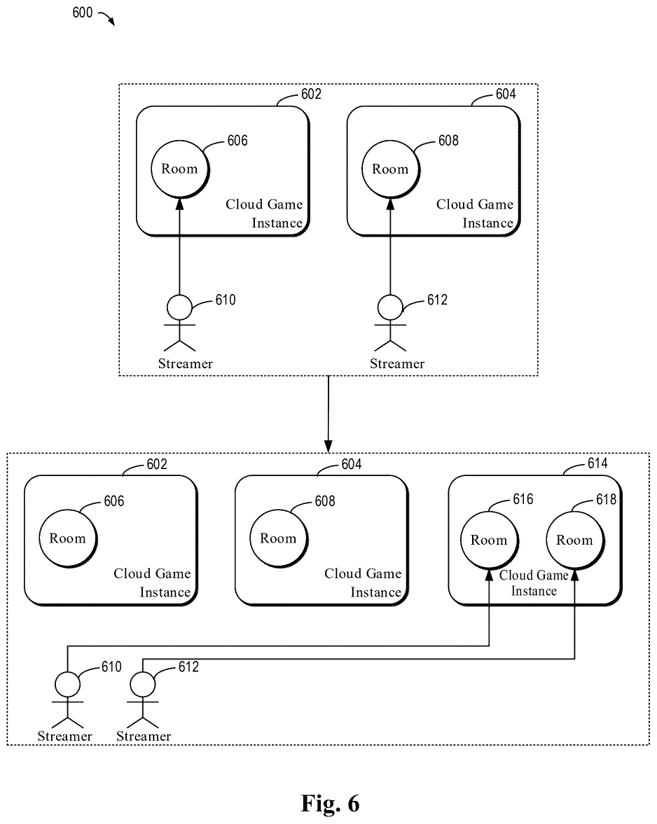

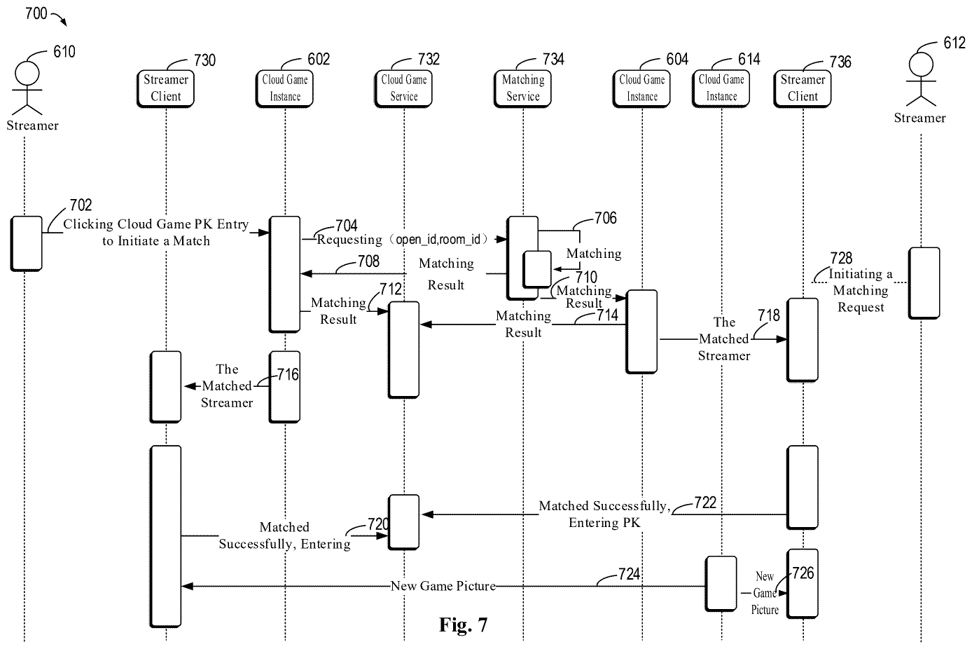

The schematic diagram of an example of one embodiment for processing a cloud game according to some embodiments of the present disclosure is described above in connection with FIG. 5. A schematic diagram of one example scenario for processing a cloud game according to some embodiments of the present disclosure is described below in conjunction with FIGS. 6-12. FIGS. 6 and 7 mainly describe the transition process of a cloud game from a single-player operation to a networked operation. For convenience of description, the playback space may be referred to as a room, and the target user and the plurality of users may be live streamers.

In example 600, when performing a single-player operation, a streamer 610 and streamer 612 as the users of a cloud game respectively provide an instance of the cloud game, that is, a cloud game instance 602 and a cloud game instance 604. The cloud game instance 602 includes a room 606, and the cloud game instance 604 includes a room 608. The room 606 and the room 608 are spaces for providing the user with game scene information in the cloud game instance, and the operation of the streamer on the cloud game may be embodied in the room. When one of the streamers issues a multiplayer networked operation request, such as a double PK operation request, the streamer 610 and streamer 612 are successfully matched. When the streamer 610 and the streamer 612 are successfully matched, the cloud game creates a new cloud game instance 614 including the room 616 and the room 618, and the streamer 610 and the streamer 612 join the room 616 and the room 618, respectively, of the cloud game instance 614 to start the cloud game. In the new instance, the streamer 610 and streamer 612 may be networked to operate the cloud game.

The example 700 of FIG. 7 illustrates the interaction between the various parts of FIG. 6. First, the cloud game instance 602 receives 702 a matching operation which involves the streamer 610 clicking the player killing (PK) entry in a cloud game to initiate a match. After receiving the matching operation, the cloud game instance 602 sends 704 a matching request to the matching service 734, where the matching request includes open_id and room_id in the cloud game instance, which may represent a user identification and a room identification, respectively. The matching service 734 then performs 706 the matching operation. Additionally, the matching service 734 performs the matching operation by matching the identification information of the streamers. The matching service 734 then sends 708 the matching result to the cloud game instance 602 and sends 710 the matching result to the cloud game instance 604. The matching result may include the matched user's identification. Next, the cloud game instance 602 sends 712 the matching result to the cloud game service 732, and the cloud game instance 604 also sends 714 the matching result to the cloud game service 732.

The cloud game instance 602 then sends 716 information to the streamer client 730 indicating that it is matched with the streamer 612, and the information includes information such as the identification of the matched object. The cloud game instance 604 sends 718 to the streamer client 736 information of the streamer 610 matched thereto, also including the identification information of the matched object. The streamer client 730 and the streamer client 736 are cloud game clients or applications comprising cloud game clients.

The streamer client 730 and streamer client 736 then send 720/722 the information to the cloud game service 732 indicating successful matching and entering PK, respectively, to join the new cloud game instance 614 provided by the cloud game service, which then sends 724/726 the new game picture for the cloud game instance 614 to the streamer client 730 and streamer client 736 such that the streamer 610 and streamer 612 see the new game picture. Additionally, the streamer 612 may also actively initiate 728 a matching request for the cloud game.

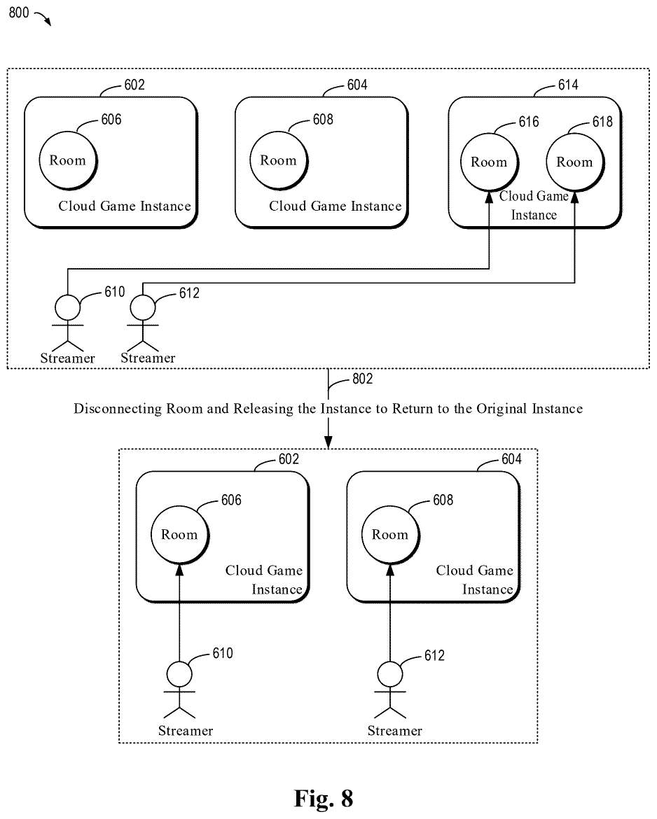

The transition of the cloud game from networked operation to single-player operation is described below in conjunction with FIGS. 8 to 12. FIG. 8 depicts a schematic diagram of an example for transitioning from networked operation to single-player operation according to some embodiments of the present disclosure. In example 800, the previous cloud game instance 602 and cloud game instance 604 need not be turned off while the streamer 610 and streamer 612 are operating in a networked manner, but the previous cloud game instance 602 and cloud game instance 604 are maintained, e.g., prior game progress is saved. After the cloud instance 614 notifies the streamer 610 and streamer 612 that the connection ends and it requires to switch back to single-player operation, at 802, the rooms 616 and 618 are disconnected, the instances are released to return to the original cloud instances 602 and 604, the streamer 610 switches back to the cloud instance 602 to continue operation, and the streamer 612 switches back to the cloud instance 604 to continue operation.

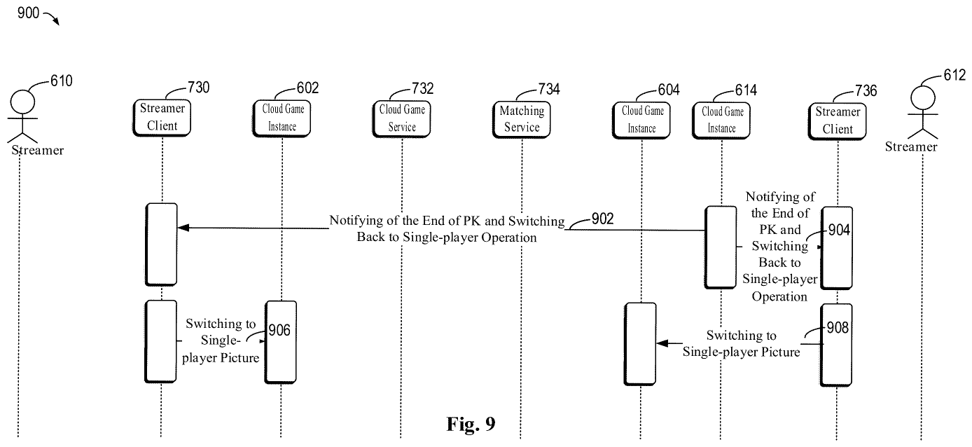

FIG. 9 depicts a schematic diagram of an example of an interactive process for transitioning from networked operation to single-player operation in FIG. 8. In example 900, the streamer client of the cloud game may perceive whether the cloud game is performing a single-player operation or is performing a multiplayer networked operation, which may save state, such as game progress information. When switching from the multiplayer networked operation to the single-person operation, it may switch on its own without server-side perception. At the end of the multiplayer networked operation, the cloud game instance 614 sends 902/904 a message to the streamer client 730 and streamer client 736, notifying of the end of the PK and that it will switch back to the single-player operation. Since the streamer client saves the state information about the previous example, then the streamer client 730 may directly send 906 a request for switching to the single-player picture to the cloud game example 602; the streamer client 736 sends 908 a request for switching to a single-player picture directly to the cloud game instance 604. Thus, streamer 610 may switch back to cloud game instance 602 to continue operation and streamer 612 switches back to cloud game instance 604 to continue operation.

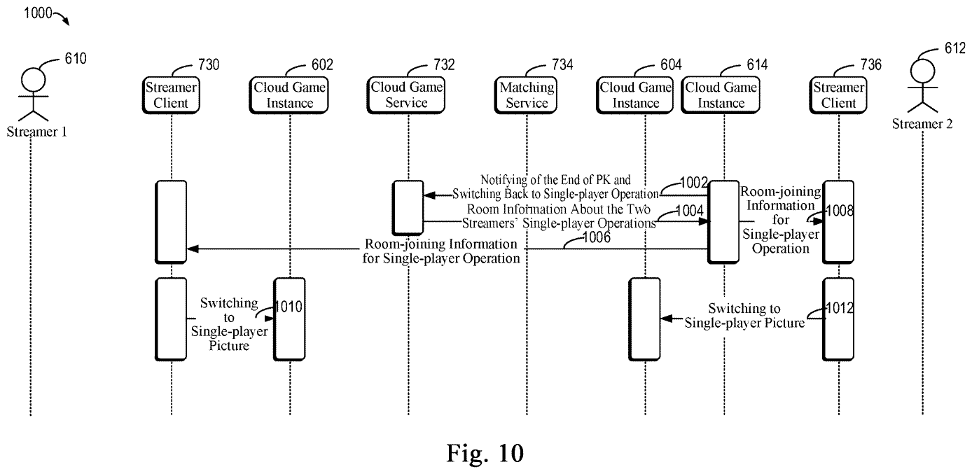

FIG. 10 depicts a schematic diagram of an example of another interactive process for transitioning from networked operation to single-player operation in FIG. 8. In example 1000, the streamer client of the cloud game may not perceive whether the cloud game is performing a single-person operation or a multiplayer networked operation, but may instead store relevant information by the server to issue the information indicating that it needs to join room to enable the switching operation. The cloud game instance 614 first sends 1002 a message to the cloud game service 732 indicating the end of PK and that it will switch back to the single-player operation, and then the cloud game service 732 returns 1004 room information about the two streamers'single-player operations to the cloud game instance 614. Cloud game instance 614 then issues 1006/1008 single-player operation room-joining information to streamer client 730 and streamer client 736, where room-joining information refers to information about the room to be joined. The streamer client 730 then sends 1010 a request to the cloud game instance 602 to switch to the single-player operation picture, and the streamer client 736 sends 1012 a request to the cloud game instance 604 to switch to the single-player operation picture. Thus, streamer 610 switches back to cloud game instance 602 to continue operation and streamer 612 switches back to cloud game instance 604 to continue operation.

Another example of a multiplayer networked operation to a single-player operation from that shown in FIGS. 6 and 7 is described below in connection with example 1100 in which, after the cloud game instance 614 notifies the streamer 610 and streamer 612 that the networked operation ends and it needs to switch back to the single-player operation, at 1102, the rooms 616 and 618 are disconnected, the cloud game instance 614 is released and new cloud game instances 1104 and 1106 are entered, entering respective rooms 1108 and 1110. That is, after the streamer 610 and the streamer 612 are disconnected from the cloud game instance 614, the streamer 610 is connected to the new cloud game instance 1104, and the streamer 612 is connected to the new cloud game instance 1106 to continue the operation of the single-player cloud game.

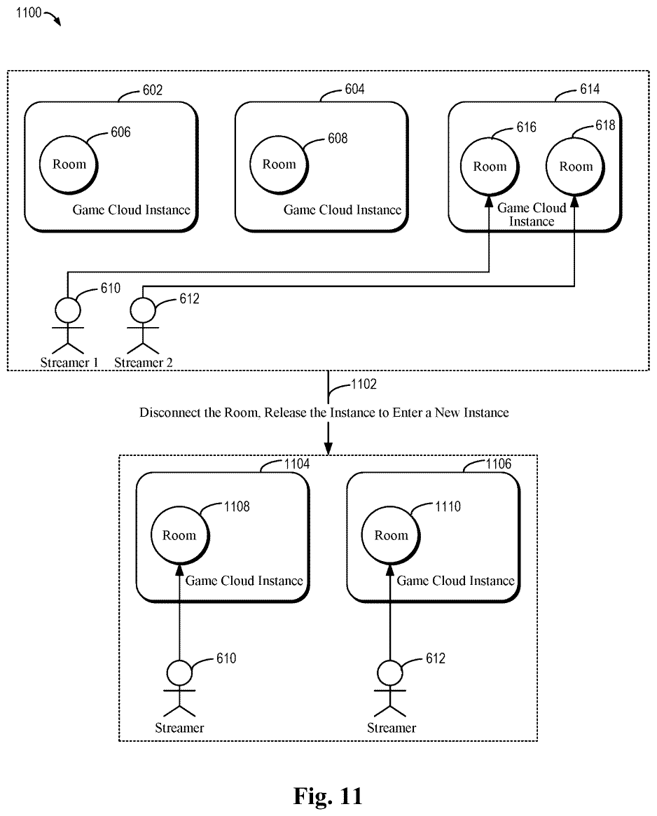

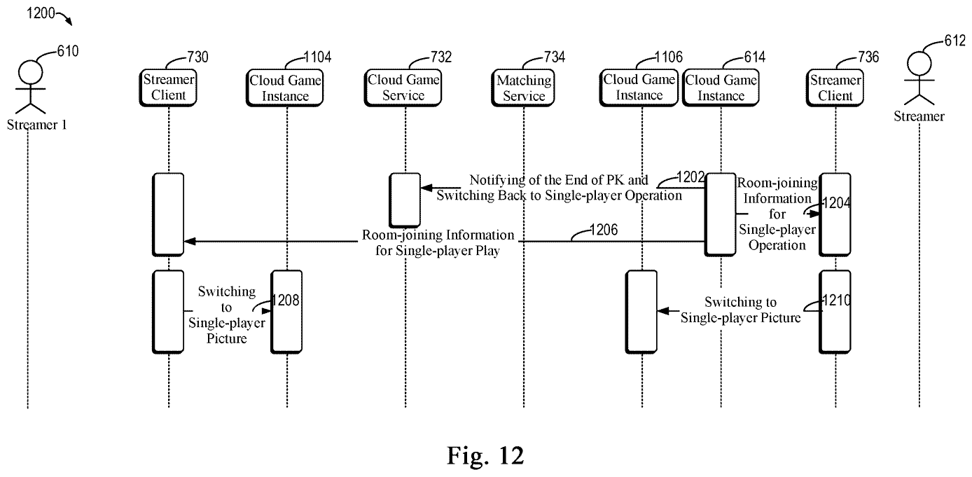

FIG. 12 illustrates an example operational interaction process of FIG. 11. In example 1200, the cloud game instance 614 first sends 1202 a message to the cloud game service 732, indicating the end of PK and that it will switch back to the single-player play. The cloud game instance 614 sends 1204/1206 single-player operation room-joining information, such as the newly created cloud game instance and its room information, directly to the streamer client 730 and streamer client 736. The streamer client 730 then sends 1208 to the cloud game instance 1104 a request for switching to single-player operation picture, to switch to the new cloud game instance 1104 for continued operation. The streamer client 736 sends 1210 to the cloud game instance 1106 a request for switching to the single-player operation picture, to switch to a new cloud game instance 1106 for continued operation.

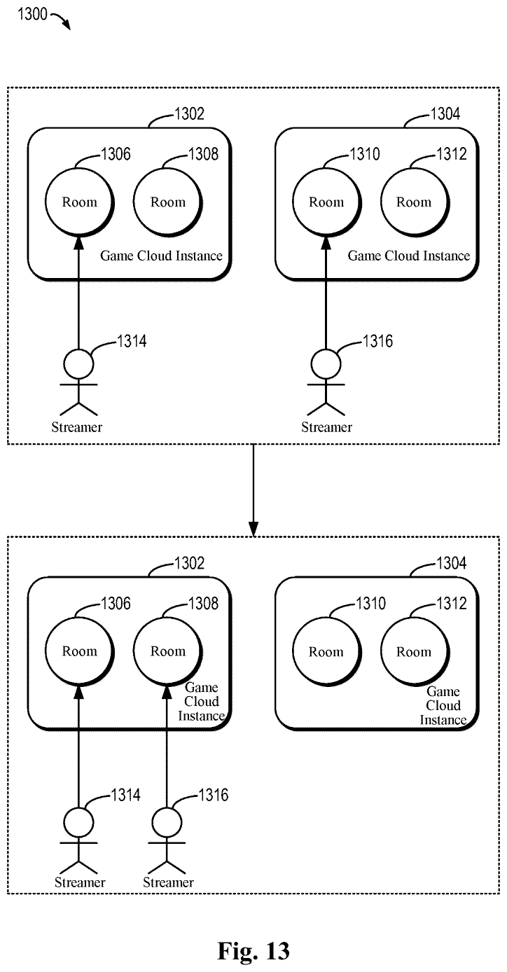

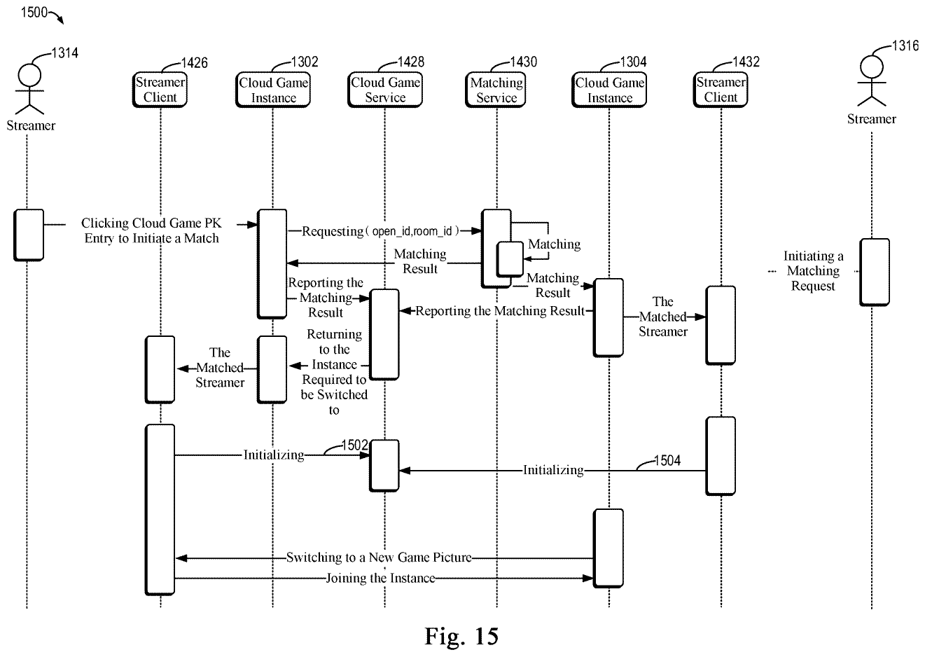

The schematic diagram of an example of a first scenario for handling a cloud game according to some embodiments of the present disclosure is described above in connection with FIGS. 6-12. A schematic diagram of an example of a second scenario for processing a cloud game according to some embodiments of the present disclosure is described below in conjunction with FIGS. 13-18. FIG. 13 illustrates a schematic diagram of an example for transitioning from single-player operation to networked operation according to some embodiments of the present disclosure.

In example 1300, when performing single-player operation, streamer 1314 and streamer 1316 operate the cloud game instances provided by the cloud game, i.e., cloud game instance 1302 and cloud game instance 1304, respectively. The cloud game instance 1302 includes room 1306 and room 1308, and cloud game instance 1304 includes room 1310 and room 1312. In this example, the user is performing a two-person PK operation, so the number of rooms in each example may be set to two. When multiple players perform PK, the number of rooms in each instance may equal to or greater than the number of multiple players. Room 1306, room 1308, room 1310, and room 1312 are spaces in which a user may operate in a cloud game instance. When the streamer 1314 and streamer 1316 are successfully matched, the streamer 1314 disconnects from the cloud game instance 1304 and joins the room 1308 in the cloud game instance 1302, thereby enabling networked operation of the streamer 1314 and streamer 1316 in the cloud game instance 1302.

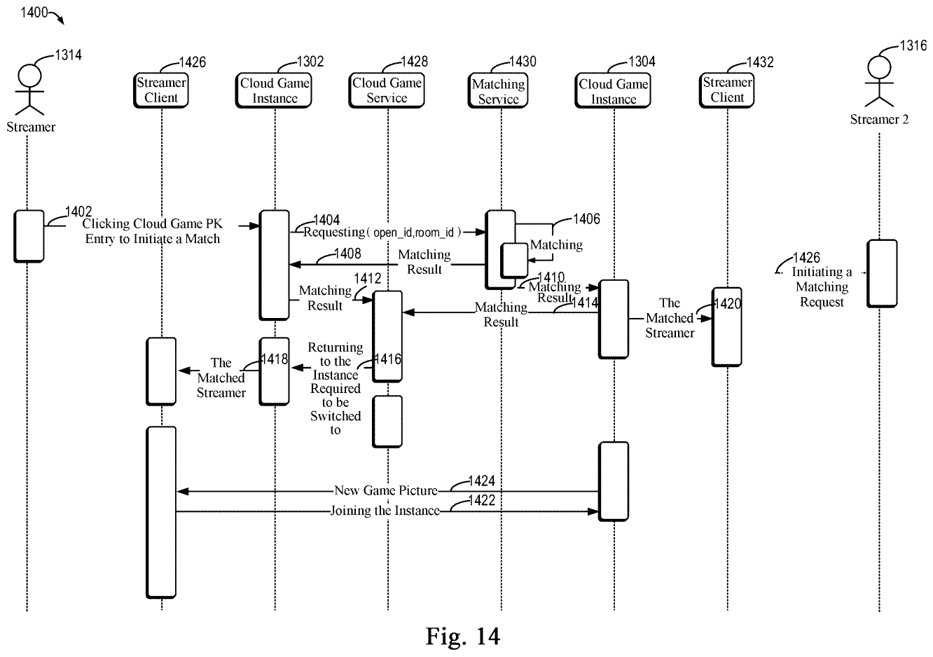

An example of the interactive process from single-player operation to networked operation in FIG. 13 is described below in conjunction with FIG. 14. In example 1400, the selected instance does not need to be initialized, but the room information is issued directly via real-time communication. First, a cloud game instance 1302 receives 1402 a matching operation which involves the streamer 1314 clicking the PK entry in a cloud game to initiate a match, and after receiving the matching operation, the cloud game instance 1302 sends 1404 a matching request to a matching service 1430. The matching request comprises open_id and room_id, which can be used to indicate an identification of a user of the cloud game instance and a room identification. Matching service 1430 then performs 1406 a matching operation to determine matched users, e.g., streamer 1314 and streamer 1316 are matched. Matching service 1430 sends 1408/1410 matching results to cloud game instance 1302 and cloud game instance 1304, respectively. Additionally, the matching service matches the streams by matching the identification information of the streamers.

After the cloud game instances 1302 and 1304 obtain a matching result, the cloud game instance 1302 and the cloud game instance 1304 respectively report 1412/1414 matching results (including selected instances) to the cloud game service 1428, and then the cloud game service returns to the cloud game instance 1302 that needs to be switched to the cloud game instance 1304, and issues real-time communication information, such as a cloud game instance needing to be joined and room information thereof. The cloud game instance 1302 then sends 1418 information to the streamer client 1426 indicating that it is matched with the streamer 1316. Cloud game instance 1304 sends 1420 information to streamer client 1432 indicating that it is matched with streamer 1314.

Then, after the streamer 1314 and streamer 1316 are matched successfully, the streamer client 1426 sends 1422 a request for indicating joining the instance to the cloud game instance 1304. The cloud game instance 1304 then sends 1424 a new game picture to the streamer client 1426. Additionally, streamer 1316 also issues 1426 a matching request for the cloud game.

Another example from single-player operation to multiplayer networked operation in FIG. 13 is described in Example 1500. This example is similar to example 1400, but in this example the select instance needs to be reinitialized. After receiving the matching result, the cloud game instance 1302 and the cloud game instance 1304 respectively report the matching result (including the selected instance) to the cloud game service, and then the cloud game service sends to the cloud game instance 1302 an instance to be switched to, and issues real-time communication information. Cloud game instance 1302 and cloud game instance 1304 then send information indicating that it is matched with streamer 1316 and streamer 1314, respectively, to streamer client 1426 and streamer client 1432, respectively.

The difference from example 1400 is that after successful matching of the streamer 1314 with the streamer 1316, the streamer client 1426 sends 1502 an initialization request to the cloud game service 1428 and the streamer client 1432 sends 1504 an initialization request to the cloud game service 1428. The initialization request, for example, may indicate a cloud game progress initialization operation. An instance of the cloud game to be joined is initialized. Other procedures are similar to example 1400.

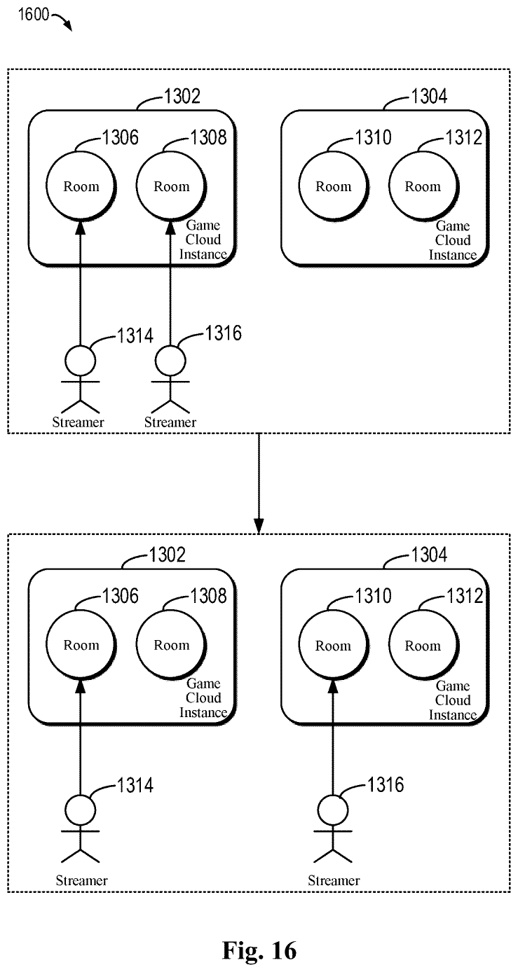

In FIGS. 16 to 18, the transition from networked operation to single-player operation in the second scheme is mainly described. FIG. 16 illustrates a schematic diagram of an example for transitioning from networked operation to single-player operation according to some embodiments of the present disclosure.

In example 1600, streamer 1313 and streamer 1316 end the multiplayer networked operation in cloud game instance 1302. When the cloud game instance 1302 notifies the streamer 1314 and the streamer 1316 that a single-player operation is required after the connection ends, the streamer 1314 continues to operate in the cloud game instance 1302, and the streamer 1316 continues to operate after the cloud game instance 1304 is switched backed to. In some embodiments, the previous cloud game instance 1302 and cloud game instance 1304 may not need to be initialized at this point, and the game progress of the previous cloud game instance 1302 and cloud game instance 1304 has been saved. Thus, streamer 1314 and streamer 1316 may return to previous game play operations. In some embodiments, cloud game instance 1302 and cloud game instance 1304 may be reinitialized to re-operate.

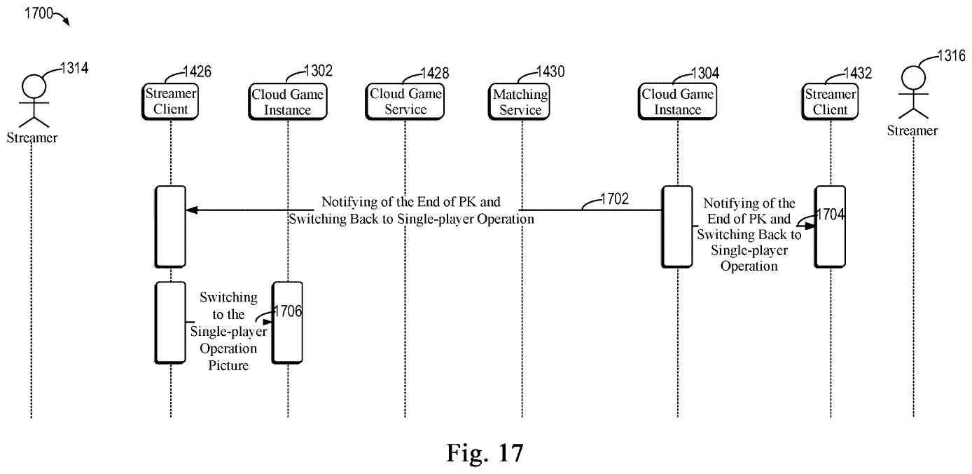

FIG. 17 illustrates a schematic diagram of an example of an interactive process for transitioning from networked operation to single-player operation corresponding to the example in FIG. 16. In this example 1700, the streamer client can perceive whether the game is under single-player operation or multiplayer operation, and needs to save the game state, and can switch on its own, without the need for service-side preciseness. Cloud game instance 1304 sends 1702/1704 information to streamer client 1426 and streamer client 1432, respectively, by notifying of the end of PK and that it will switch back to single-player operation. The mode of operation of the streamer 1316 is then switched to single-player operation and the operation of the cloud game instance 1304 continues. Since the streamer client stores the game state, the streamer 1314 may also send a request to switch to the single-player operation picture directly to the cloud game instance 1302 through the streamer client 1426 to continue operating the cloud game instance 1302.

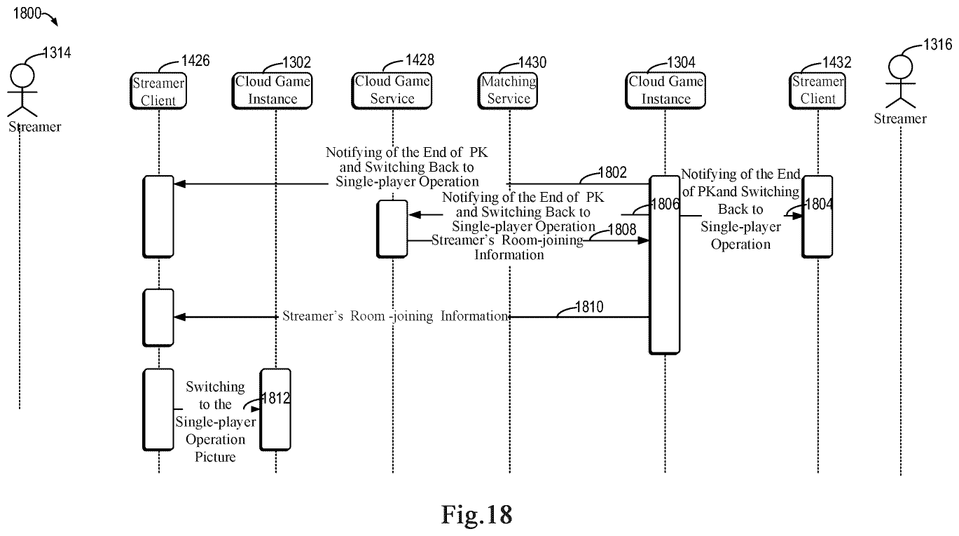

FIG. 18 illustrates a schematic diagram of an example of another interactive process for transitioning from networked operation to single-player operation corresponding to the example in FIG. 16. In this example, the streamer client 1426 does not need to perceive that it is a single-person operation or a multiplayer operation, and the service end issues room information that needs to be joined to enable switching, and at this time, state information related to the instance is stored by the server. In example 1800, cloud game instance 1304 notifies 1802/1804 streamer client 1426 and streamer client 1432 of the end of the networked PK operation and the switch back to single-player operation. The cloud game instance 1304 also notifies 1806 the cloud game service the end of the networked PK and that it will switch back to single-player operation. The cloud game instance 1304 is then informed 1808 by the cloud game service 1428 to issue room-joining information for the streamer 1314, the cloud game instance 1304 further issues 1810 the streamer 1314 room-joining information, and finally sends 1812 a request indicating switching to the single-player operation picture to the cloud game instance 1302 at the streamer client 1426 to enable communication with the cloud game instance 1302.

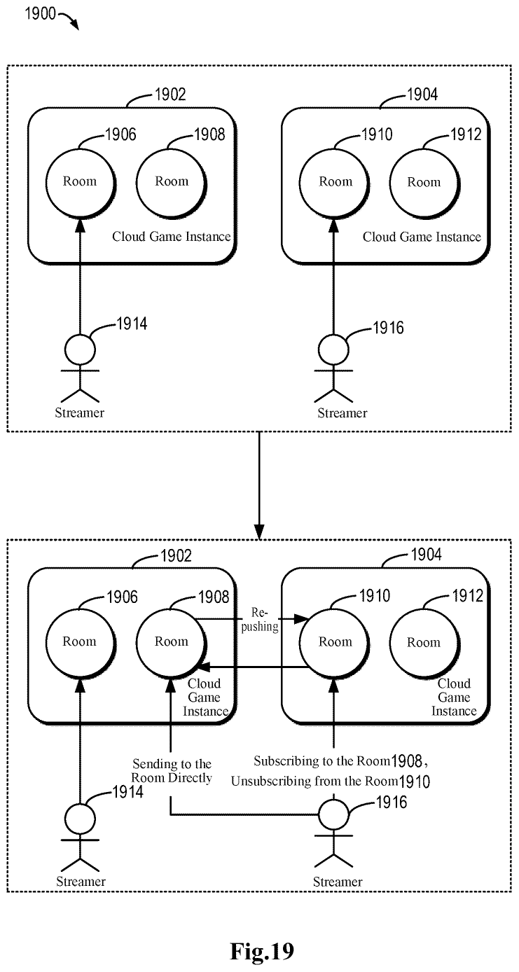

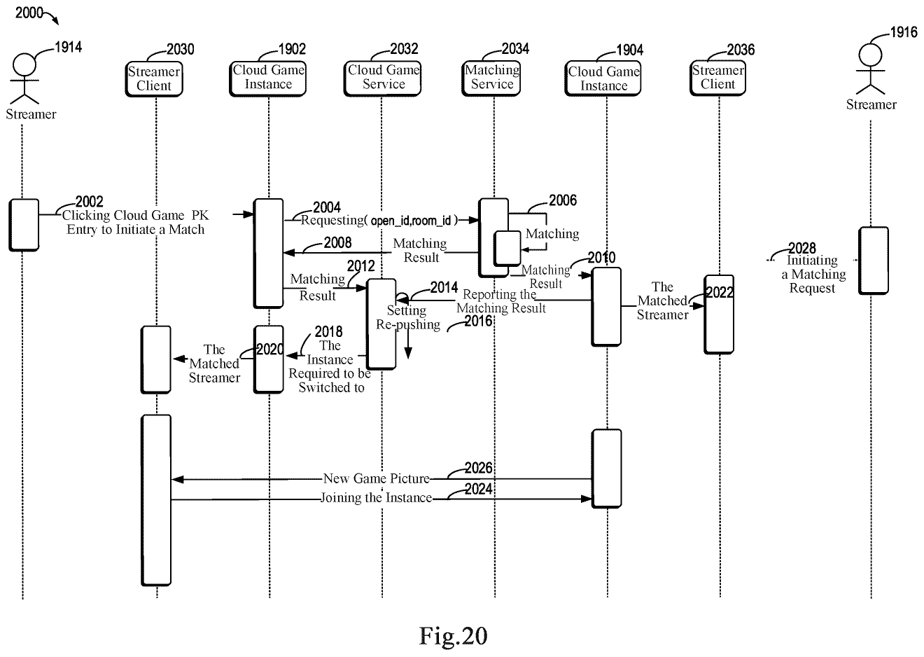

A schematic diagram of an example of a second scenario for handling a cloud game according to some embodiments of the present disclosure is described above in connection with FIGS. 13-18. A schematic diagram of an example of a third scenario for processing a cloud game according to some embodiments of the present disclosure is described below in conjunction with FIGS. 19-23. In FIGS. 19 to 20, a transition process from a single-player operation to a networked operation when operating the cloud game in the third aspect is mainly described. FIG. 19 illustrates a schematic diagram of an example for transitioning from single-player operation to networked operation according to some embodiments of the present disclosure.

In the example 1900, streamer 1914 and streamer 1916 operate the cloud game instances provided by the cloud game, namely, the cloud game instance 1902 and the cloud game instance 1904, respectively. The cloud game instance 1902 includes a room 1906 and a room 1908 therein, and the cloud game instance 1904 includes a room 1910 and a room 1912 therein, and the room 1906, the room 1908, the room 1910 and the room 1912 are spaces in which a user can operate in the cloud game instance.

When streamer 1914 and streamer 1916 are playing under single-player operation, streamer 1914 operates in room 1906 of cloud game instance 1902 and streamer 1916 operates in room 1910 of cloud game instance 1904. When either streamer 1914 or streamer 1916 initiates a networked operation request, the streamer 1914 is matched with the streamer 1916 successfully. Next, the streamer 1916 subscribes to the room 1908 and unsubscribes from the room 1910. After the streamer 1916 successfully subscribes to the stream-pushing for the room 1908, the streamer's operations may be sent directly to the room 1908. The cloud game service may forward the cloud game content of room 1908 to room 1910. The streamer 1914 and streamer 1916 thus form a networked play in the cloud game instance 1902, and the audio-video picture of the streamer 1916 in the room 1908 of the cloud game instance 1902 may also be received in the room 1910 of the cloud game instance 1904 for re-pushing to the streamer 1916.

FIG. 20 illustrates a schematic diagram corresponding to FIG. 19 of an example of an interactive process for transitioning from single-player operation to networked operation. The cloud game instance 1902 first receives 2002 a matching operation which involves the streamer 1914 clicking the PK entry in a cloud game to initiate a match. After receiving the matching operation, the cloud game instance 1902 sends 2004 a matching request for performing a multiplayer networked operation to the matching service 2032, wherein the matching request comprises a user identification and a room identification in the cloud game instance, such as open_id and room_id. Then, the matching operation is then performed 2006, and after matching, the matching service 2034 sends 2008/2010 the matching result to the cloud game instance 1902 and the cloud game instance 1904 respectively. Additionally, the matching service performs the matching by matching the identification information of the streamers.

After receiving the matching result, the cloud game instance 1902 and the cloud game instance 1904 respectively report 2012/2014 matching result (including the selected instance) to the cloud game service 2032, then set 2016 re-pushing on the cloud game service 2032, and at 2018, the cloud game service 2032 returns 2018 the cloud game instance 1904 to which needs to be switched to the cloud game instance 1902, and issues information about real-time communication information to the cloud game instance 1902. Cloud game instance 1902 and cloud game instance 1904 send 2020/2022 the information of the matched streamers 1904, 1902 to streamer client 2030 and streamer client 2036, respectively.

The streamer client 2030 then sends 2024 an instance-joining request to the cloud game instance 1904. Cloud game instance 1904, upon receiving the request, sends a new game picture to streamer client 2030, whereby streamer 1914 and streamer 1916 form a networked operation in cloud game instance 1904. Additionally, the streamer 1916 also issues 2038 a matching request for the cloud game.

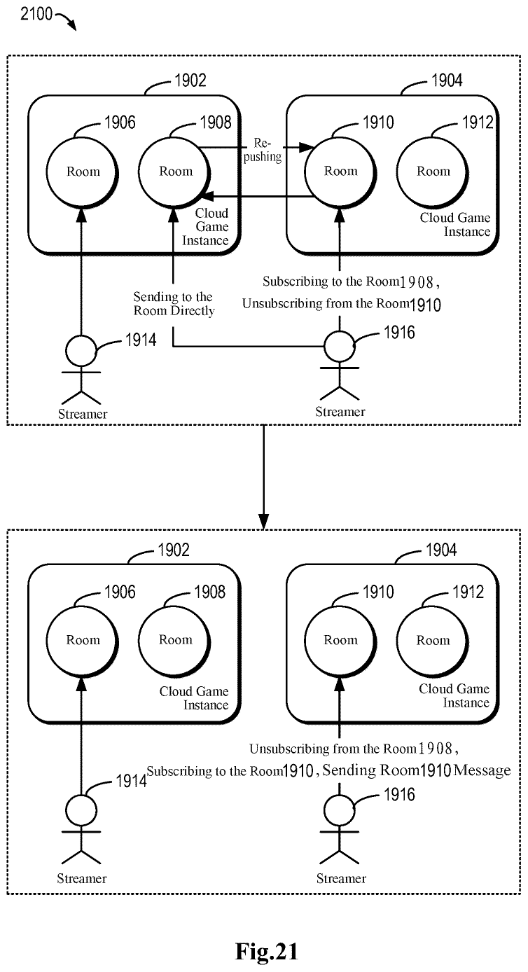

FIGS. 21 to 23 mainly describe the transition process from the networked operation to the single-player operation when operating the cloud game in the third aspect. FIG. 21 illustrates a schematic diagram of an example for transitioning from networked operation to single-player operation according to some embodiments of the present disclosure.

In the example 2100, after the cloud game instance 1904 notifies the streamer 1914 and the streamer 1916 that the networked operation ends and it will switch back to single-player operation, the streamer 1916 unsubscribes from the room 1908, subscribes to the room 1910, and sends the room 1910 message. Thereafter, the streamer 1914 continues to operate in the cloud game instance 1902 and the streamer 1916 switches back to the cloud game instance 1904 to continue operation.

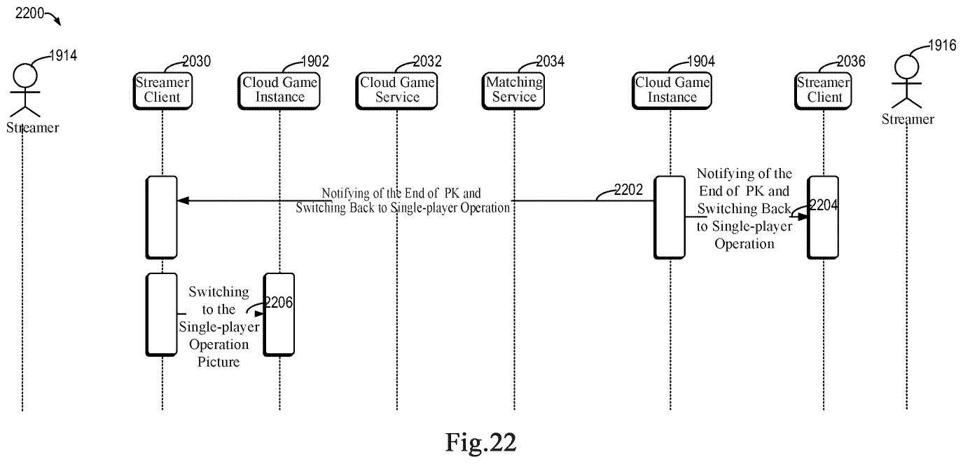

FIG. 22 illustrates a schematic diagram corresponding to FIG. 21 of an example of an interactive process for transitioning from networked operation to single-player operation. In this example, the cloud game client can determine whether the game is operated in a single-player manner or in a networked manner by multiple persons, and can save the game state to achieve self-switching without the need for the server to join the switching process.

In example 2200, the cloud game instance 1904 sends 2202/2204 the information notifying of the end of the PK and that it will switch back to single-player operation to the streamer client 2030 and the streamer client 2036, and at the same time switches the operation mode of the streamer 1916 to the single-player operation and continues to operate the cloud game instance 1904. The streamer client 2030 then sends 2206 a request indicating switching to a single-player operation picture to the cloud game instance 1902 to continue operating the cloud game instance 1902.

Additionally, when switching to single-player play, the progress of the cloud game in the cloud game instance may not be initialized, i.e., the progress of the cloud game in the room in the cloud game instance 1902 remains unchanged, and the progress of the cloud game in the room in the cloud game instance 1904 is the progress of the game where the master 1916 was located before entering networked play.

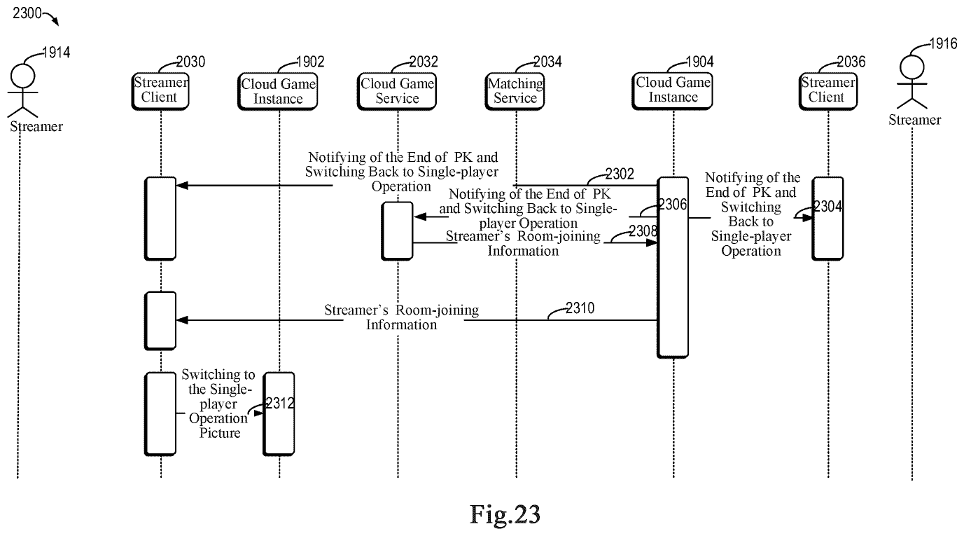

FIG. 23 illustrates a schematic diagram corresponding to FIG. 21 of an example of another interactive process for transitioning from networked operation to single-player operation. In this example, the cloud game client does not need to determine whether the cloud game is a single-person operation or a multiplayer networked operation, and the service end issues information about a room to be joined to switch operations.

In this flow, the cloud game instance 1904 notifies 2302/2304 the streamer client 2030 and the streamer client 2306 that the networked PK operation ends and it will switch back to the single-player operation, and at the same time notifies 2306 the cloud game service 2032 that the networked PK ends and it requires to switch back to the single-player operation. The streamer 1914's room-joining information, i.e., the room in which the streamer 1914 is to join, is then issued by the cloud game service via notifying 2308 cloud game instance 1904. Cloud game instance 1914 further notifies 2310 the streamer client of the room-joining information of streamer 1914. Finally, the streamer client 2030 sends 2312 a request to the cloud game instance 1902 to switch to a single-player operation picture. The streamer 1914 switches the cloud game instance 1902 to the single-player operation and also switches the cloud game instance 1904 to the single-player operation at the streamer 1916.

In some embodiments, cloud game instance 1902 and cloud game instance 1904 save the state of the game before the streamer joins the networked operation, and may continue to operate in the original game state when returning to the single-player operation. In some embodiments, when switching to the single-player play, the progress of the cloud game in the cloud game instance is initialized, i.e., the cloud game in the room in the cloud game instance 1902 and the cloud game progress in the room in the cloud game instance 1904 are all initialized to the initial game progress, and then the streamer 1914 and streamer 1916 begin single-player operation from the initial progress of the cloud game.

The above example describes an example of two streamers joining networked operations, which is intended to be merely illustrative of the present disclosure and not a specific limitation thereof. The number of users joining the multiplayer networked operation may be multiple.

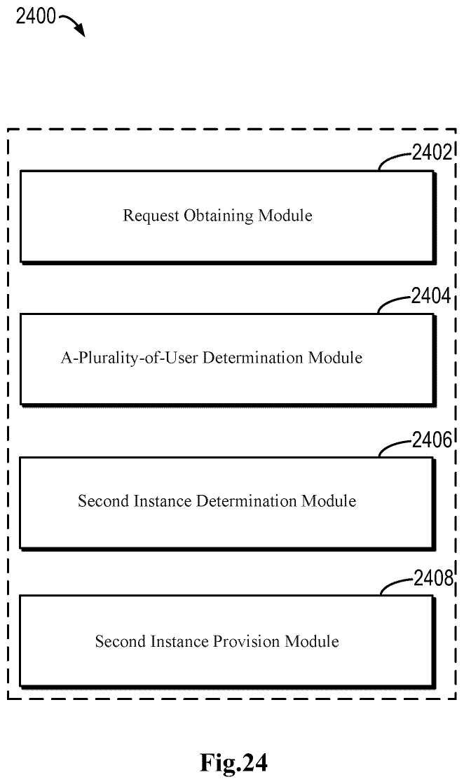

As shown in FIG. 24, an apparatus 2400 comprises a request obtaining module 2402 configured to obtain a request for performing a multiplayer networked operation on a cloud game from a first instance of the cloud game, the cloud game being a single-player game, and the first instance being operated by a target user; a-plurality-of-user determination modules 2404 configured to determine, based on the request, a plurality of users for performing a multiplayer networked operation on the cloud game, the plurality of users having been assigned a plurality of instances of the cloud game, the plurality of instances being incapable of performing data interaction therebetween, and the plurality of instances including the first instance; a second instance determination module 2406 configured to determine a second instance of a cloud game available for multiplayer networked operation by the plurality of users; and a second instance provision module 2408 configured to provide a second instance for the plurality of users to perform a multiplayer networked operation in the second instance.

In some embodiments, the-plurality-of-user determination modules 2404 includes: a user identification determination module configured to determine a user identification of the target user in the request; a user cluster determination module configured to determine a user cluster that is able to join the networked operation on the cloud game; and a plurality of user selection modules configured to select, based on the user identification and from the user cluster, the plurality of users that are available for the multiplayer networked operation on the cloud game.

In some embodiments, the second instance determination module 2406 includes: a number determination module of a plurality of users configured to determine a number of the plurality of users for performing the multiplayer networked operation; and a second instance creation module configured to create a second instance having the number of playback spaces, each of the plurality of users having a corresponding playback space.

In some embodiments, the second instance determination module 2406 includes: a predetermined number of playback space determination module configured to determine that each instance in a group of instances among the plurality of instances comprises a predetermined number of playback spaces, the predetermined number being greater than or equal to a number of the plurality of users; and an instance selection module configured to select an instance from a group of instances as a second instance.

In some embodiments, if the first instance is different from the second instance, and the second instance provision module 2408 includes: an identification provision module of the second instance configured to provide an identification of the second instance to a target cloud game client for the target user; and an establishment communication module configured to establish communication between the target cloud game client and the corresponding playback space in the second instance in response to receiving a joining request from the target cloud game client.

In some embodiments, the establishment communication module includes: a joining request receiving module configured to receive the joining request from the target cloud game client via the second instance; and a content provision module configured to provide content of the corresponding playback space in the second instance to the target cloud game client.

In some embodiments, the an establishment communication module includes: a subscription request receiving module configured to receive a subscription request for subscribing to content of the corresponding playback space in the second instance from the first instance corresponding to the target user; and a content pushing module configured to push content from the corresponding playback space into the first instance based on the subscription request to provide the content to the target cloud game client via the first instance.

In some embodiments, the apparatus 2400 further includes: a subscription cancellation module configured to cancel the subscription of the first instance to the content of the corresponding playback space in the second instance in response to an end of the multiplayer networked operation for the second instance; and a content provision module in the playback space in the first instance configured to provide the content in the playback space in the first instance to the target cloud game client.

In some embodiments, wherein the second instance is different from the first instance, the apparatus 2400 further includes: a first instance maintenance module configured to maintain the first instance while providing the second instance; and a first instance provision module configured to provide the first instance to the target user in response to an end of the multiplayer networked operation for the second instance.

In some embodiments, the first instance provision module includes: an association information obtaining module configured to obtain association information between the first instance and the target user; and a first instance provision module configured to provide the first instance to the target user based on the association information.

In some embodiments, where the plurality of instances is the first plurality of instances, the apparatus 2400 further includes: a second plurality of instance creation modules configured to create a second plurality of instances of the cloud game for the plurality of users in response to an end of the multiplayer networked operation for the second instance; and a second plurality of instance provision modules configured to provide the second plurality of instances to the plurality of users.

In some embodiments, the apparatus 2400 further includes: an identification provision module of a plurality of users configured to provide identifications of the plurality of users to the plurality of instances; and an identification provision module of a plurality of users configured to provide the identifications of the plurality of users to the plurality of cloud game clients corresponding to the plurality of users through the plurality of instances.

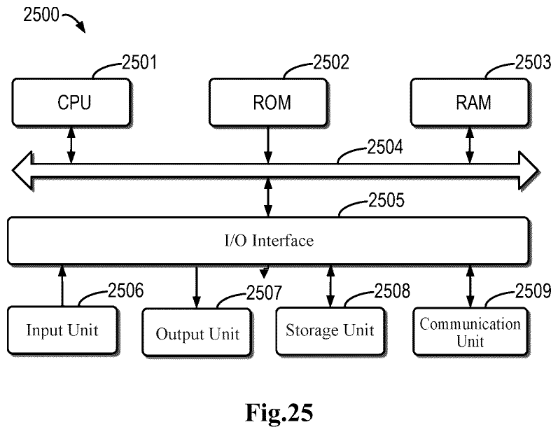

FIG. 25 shows a schematic block diagram of an example device 2500 that may be used to implement embodiments of the present disclosure. The server 102 in FIG. 1 may be implemented using the device 2500. As shown, device 2500 includes a central processing unit (CPU) 2501 that may perform various suitable actions and processes in accordance with computer program instructions stored in a read only memory (ROM) 2502 or loaded from storage unit 808 into a random-access memory (RAM) 2503. In the RAM 2503, various programs and data necessary for the operation of the device 2500 can also be stored. The CPU 2501, the ROM 2502, and the RAM 2503 are connected to each other via a bus 2504. An input/output (I/O) interface 2505 is also connected to the bus 2504.

Various components in the device 2500 are connected to the I/O interface 2505, including: an input unit 2506, such as a keyboard, a mouse, etc.; an output unit 2507 such as various types of displays, speakers, etc.; a storage page 2508, such as a magnetic disk, an optical disk, etc.; and a communication unit 2509, such as a network card, a modem, a wireless communication transceiver, etc. The communication unit 2509 allows the device 2500 to exchange information/data with other devices over a computer network such as the Internet and/or various telecommunication networks. Tonal skills, vocal practice, biting and spitting, breath, falsification and correct singing method2.

The various processes and processes described above, such as method 200 and examples 300 through 2300, may be performed by processing unit 2501. For example, in some embodiments, method 200 and examples 300-2300 may be implemented as a computer software program tangibly embodied on a machine-readable medium, such as storage unit 2508. In some embodiments, some or all of the computer programs may be loaded and/or installed on device 2500 via ROM 2502 and/or communication unit 2509. The computer programs, when loaded into RAM 2503 and executed by CPU 2501, may perform one or more of the actions of exemplary method 200 and examples 300 through 2300 described above.

The disclosure may be a method, apparatus, system, and/or computer program product. The computer program product may include a computer-readable storage medium having computer-readable program instructions embodied thereon for performing various aspects of the disclosure.

A computer-readable storage medium may be a tangible device that can hold and store instructions for use by an instruction execution device. The computer-readable storage medium may be, for example but not limited to, an electronic memory device, a magnetic memory device, an optical memory device, an electromagnetic memory device, a semiconductor memory device, or any suitable combination of the preceding. More specific examples (a non-exhaustive list) of the computer-readable storage medium include: A portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disc (DVD), a memory stick, a floppy disk, a mechanical coding device such as a punch card or a raised-in-groove structure on which instructions are stored, and any suitable combination thereof. A computer-readable storage medium, as used herein, is not to be construed as a transient signal itself, such as a radio wave or other freely-propagating electromagnetic wave, an electromagnetic wave propagating through a waveguide or other transmission medium (e.g., an optical pulse through a fiber optic cable), or an electrical signal transmitted through an electrical wire.

The computer-readable program instructions described herein may be downloaded from a computer-readable storage medium to various computing/processing devices, or to external computers or external storages over a network, such as the Internet, a local area network, a wide area network, and/or a wireless network. The network may include copper transmission cables, fiber optic transmissions, wireless transmissions, routers, firewalls, switches, gateway computers, and/or edge servers. A network adapter card or network interface in each computing/processing device receives the computer readable program instructions from the network and forwards the computer readable program instructions for storage in a computer readable storage medium in the respective computing/processing device.

Computer program instructions for carrying out operations of the present disclosure may be assembler instructions, instruction set architecture (ISA) instructions, machine instructions, machine dependent instructions, microcode, firmware instructions, state setting data, or source or object code written in any combination of one or more programming languages, including object oriented programming languages, such as Smalltalk, C++ and the like, and conventional procedural programming languages, such as the “C” language or similar programming languages. The computer-readable program instructions may execute entirely on the user's computer, partly on the user's computer, as a single-player software package, partly on the user's computer, partly on a remote computer, or entirely on the remote computer or server. In the case of a remote computer, the remote computer may be connected to the user's computer through any type of network, including a local area network (LAN) or a wide area network (WAN), or it may be connected to an external computer (e.g., through the Internet using an Internet Service Provider). In some embodiments, various aspects of the present disclosure may be implemented by individually customizing an electronic circuit, such as a programmable logic circuit, a field programmable gate array (FPGA), or a programmable logic array (PLA), with state information of computer-readable program instructions, which may execute the computer-readable program instructions.

Various aspects of the disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer readable program instructions may be provided to a processing unit of a general-purpose computer, special purpose computer, or other programmable data processing apparatus to produce a machine, such that the instructions, when executed by the processing unit of the computer or other programmable data processing apparatus, create means for implementing the functions/acts specified in the flowchart and/or block diagram block or blocks. These computer-readable program instructions may also be stored in a computer-readable storage medium, which may cause a computer, programmable data processing apparatus, and/or other devices to function in a particular manner, such that the computer-readable medium having stored thereon instructions comprises an article of manufacture including instructions which implement various aspects of the functions/acts specified in the flowchart and/or block diagram block or blocks.

The computer readable program instructions may also be loaded onto a computer, other programmable data processing apparatus, or other device to cause a series of operational steps to be performed on the computer, other programmable data processing apparatus, or other device to produce a computer implemented process such that the instructions which execute on the computer, other programmable data processing apparatus, or other device implement the functions/acts specified in the flowchart and/or block diagram block or blocks.

The flowcharts and block diagrams in the Drawings illustrate the architecture, functionality, and operation of possible implementations of systems, methods and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Drawings. For example, two successive blocks may in fact be executed substantially in parallel, or they may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

Having described embodiments of the present disclosure, the foregoing description is illustrative, not exhaustive, and not limited to the disclosed embodiments. Many modifications and variations will be apparent to those of ordinary skill in the art without departing from the scope and spirit of the described embodiments. The terminology used herein is chosen in order to best explain the principles of the embodiments, practical applications, or technological improvements over the state of the art, or to enable others of ordinary skill in the art to understand the embodiments disclosed herein.

I/We claim:

1. A method for processing a cloud game, comprising:
obtaining a request for performing a multiplayer networked operation on the cloud game from a first instance of the cloud game, the cloud game being a single-player game, and the first instance being operated by a target user;
determining, based on the request, a plurality of users for performing the multiplayer networked operation on the cloud game, the plurality of users having been assigned a plurality of instances of the cloud game, the plurality of instances being incapable of performing data interaction therebetween, and the plurality of instances comprising the first instance;
determining a second instance of the cloud game available for the multiplayer networked operation by the plurality of users; and
providing the second instance for the plurality of users to perform a multiplayer networked operation in the second instance.

2. The method of claim 1, wherein determining the plurality of users for performing multiplayer networked operation on the cloud game comprises:
determining a user identification of the target user in the request;
determining a user cluster that is able to join the networked operation on the cloud game; and
selecting, based on the user identification and from the user cluster, the plurality of users that are available for the multiplayer networked operation on the cloud game.

3. The method of claim 1, wherein determining the second instance of the cloud game available for the multiplayer networked operation by the plurality of users comprises:
determining a number of the plurality of users for performing the multiplayer networked operation; and
creating a second instance having the number of playback spaces, each of the plurality of users having a corresponding playback space.

4. The method of claim 1, wherein determining the second instance of the cloud game available for the multiplayer networked operation by the plurality of users comprises:
determining that each instance in a group of instances among the plurality of instances comprises a predetermined number of playback spaces, the predetermined number being greater than or equal to a number of the plurality of users; and
selecting an instance from the group of instances as the second instance.

5. The method of claim 4, wherein the first instance is different from the second instance, and wherein providing the second instance for the plurality of users to perform the multiplayer networked operation in the second instance comprises:
providing the identification of the second instance to a target cloud game client for the target user; and
establishing, in response to receiving a joining request from the target cloud game client, communication between the target cloud game client and the corresponding playback space in the second instance.

6. The method of claim 5, wherein establishing the communication between the target cloud game client and the corresponding playback space in the second instance comprises:
receiving the joining request from the target cloud game client via the second instance; and
providing content of the corresponding playback space in the second instance to the target cloud game client.

7. The method of claim 5, wherein establishing the communication between the target cloud game client and the corresponding playback space in the second instance comprises:
receiving a subscription request for subscribing to content of the corresponding playback space in the second instance from the first instance corresponding to the target user; and
pushing, based on the subscription request, the content from the corresponding playback space into the first instance to provide the content to the target cloud game client via the first instance.

8. The method of claim 7, further comprising:
canceling, in response to an end of the multiplayer networked operation for the second instance, the subscription of the first instance to the content of the corresponding playback space in the second instance; and
providing the content in the playback space in the first instance to the target cloud game client.

9. The method of claim 1, wherein the second instance is different from the first instance, and the method further comprising:
maintaining the first instance while providing the second instance; and
providing the first instance to the target user in response to an end of the multiplayer networked operation for the second instance.

10. The method of claim 9, wherein providing the first instance to the target user comprises:
obtaining association information between the first instance and the target user; and
providing the first instance to the target user based on the association information.

11. The method of claim 1, wherein the plurality of instances is a first plurality of instances, and the method further comprises:
creating, in response to an end of the multiplayer networked operation for the second instance, a second plurality of instances of the cloud game for the plurality of users; and
providing the second plurality of instances to the plurality of users.

12. The method of claim 1, further comprising:
providing identifications of the plurality of users to the plurality of instances; and
providing, through the plurality of instances, the identifications of the plurality of users to a plurality of cloud game clients corresponding to the plurality of users.

13. An electronic device comprising:
at least one processor; and
a storage for storing at least one program which, when executed by the at least one processor, causes the at least one processor to:
obtain a request for performing a multiplayer networked operation on the cloud game from a first instance of the cloud game, the cloud game being a single-player game, and the first instance being operated by a target user;
determine, based on the request, a plurality of users for performing the multiplayer networked operation on the cloud game, the plurality of users having been assigned a plurality of instances of the cloud game, the plurality of instances being incapable of performing data interaction therebetween, and the plurality of instances comprising the first instance;
determine a second instance of the cloud game available for the multiplayer networked operation by the plurality of users; and
provide the second instance for the plurality of users to perform a multiplayer networked operation in the second instance.

14. The electronic device of claim 13, wherein the program configured to determine the second instance of the cloud game available for the multiplayer networked operation by the plurality of users further causes the at least one processor to:
determine that each instance in a group of instances among the plurality of instances comprises a predetermined number of playback spaces, the predetermined number being greater than or equal to a number of the plurality of users; and
select an instance from the group of instances as the second instance.

15. The electronic device of claim 14, wherein the first instance is different from the second instance, and wherein the program configured to provide the second instance for the plurality of users to perform the multiplayer networked operation in the second instance further causes the at least one processor to:
provide the identification of the second instance to a target cloud game client for the target user; and
establish, in response to receiving a joining request from the target cloud game client, communication between the target cloud game client and the corresponding playback space in the second instance.

16. The electronic device of claim 15, wherein the program configured to establish the communication between the target cloud game client and the corresponding playback space in the second instance further causes the at least one processor to:
receive the joining request from the target cloud game client via the second instance; and
provide content of the corresponding playback space in the second instance to the target cloud game client.

17. A non-transitory computer-readable storage medium having a computer program stored thereon, wherein the computer program, when executed by a processor, causes the processor to:
obtain a request for performing a multiplayer networked operation on the cloud game from a first instance of the cloud game, the cloud game being a single-player game, and the first instance being operated by a target user;
determine, based on the request, a plurality of users for performing the multiplayer networked operation on the cloud game, the plurality of users having been assigned a plurality of instances of the cloud game, the plurality of instances being incapable of performing data interaction therebetween, and the plurality of instances comprising the first instance;
determine a second instance of the cloud game available for the multiplayer networked operation by the plurality of users; and
provide the second instance for the plurality of users to perform a multiplayer networked operation in the second instance.

18. The storage medium of claim 17, wherein the second instance is different from the first instance, and the computer program further causes the processor to:
maintain the first instance while providing the second instance; and
provide the first instance to the target user in response to an end of the multiplayer networked operation for the second instance.

19. The storage medium of claim 18, wherein the computer program configured to provide the first instance to the target user further causes the processor to:
obtain association information between the first instance and the target user; and
provide the first instance to the target user based on the association information.

20. The storage medium of claim 17, wherein the plurality of instances is a first plurality of instances, and the computer program further causes the processor to:
create, in response to an end of the multiplayer networked operation for the second instance, a second plurality of instances of the cloud game for the plurality of users; and
provide the second plurality of instances to the plurality of users.
